(19) United States
(12) Patent Application Publication
(10) Pub. No.: US 2010/0247880 A1
(43) Pub. Date: Sep. 30, 2010

(54) NOVEL COPOLYMER, NOVEL COPOLYMER-CONTAINING COMPOSITION, LAMINATE BODY, METHOD OF PRODUCING METAL FILM-COATED MATERIAL, METAL FILM-COATED MATERIAL, METHOD OF PRODUCING METALLIC PATTERN-BEARING MATERIAL AND METALLIC PATTERN-BEARING MATERIAL

(75) Inventors: Takeyoshi KANO, Kanagawa (JP); Tomomi TATEISHI, Kanagawa (JP); Tokihiko MATSUMURA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/749,531

(22) Filed: Mar. 30, 2010

(30) Foreign Application Priority Data
Mar. 31, 2009 (JP) 2009-085301

(51) Int. Cl. B32B 3/10; C08F 222/30; C08L 39/00; B32B 27/00; B32B 15/08; C25D 5/56

(52) U.S. Cl. 428/209; 526/298; 524/555; 428/411.1; 428/457; 205/164

(57) ABSTRACT

There is provided a polymer containing a unit represented by the following Formula (1), and a unit represented by following Formula (2). In Formula (1) and Formula (2), R¹ to R⁵ each independently represent a hydrogen atom, a substituted or unsubstituted alkyl group; R⁶ represents an unsubstituted alkyl group, alkenyl group, alkynyl group or an aryl group; V and Z each independently represent a single bond, a substituted or unsubstituted divalent organic group, an ester group, an amide group or an ether group, and L¹ and L² each independently represent a substituted or unsubstituted divalent organic group.

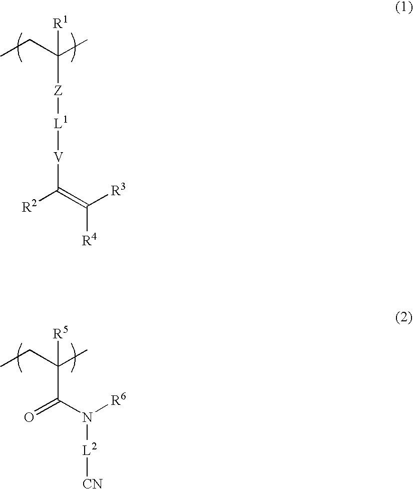

This application claims priority under 35 USC 119 from Japanese Patent Application No. 2009-085301 filed on Mar. 31, 2009, the disclosure of which is incorporated by reference herein.

### BACKGROUND OF THE INVENTION

1. Field of the Invention

The present invention relates to a novel copolymer, a composition containing the novel copolymer, a laminate body using the composition, a method of producing metal film-coated material, a metal film-coated material obtained from the method of producing metal-film material, a method of producing a metallic pattern and a metallic pattern-bearing material obtained from the method of producing a metallic pattern-bearing material.

2. Description of the Related Art

Conventionally, photocurable resin compositions are used for surface treatment materials, resist materials, printing plate materials, coating materials and stereolithographic materials, based on the outstanding feature of the photocurable resin compositions.

Of the photocurable resin compositions, a material cured by radical polymerization is generally formed of a binder, a polyfunctional monomer and a photopolymerization initiator. In this case, as a technique of raising photocuring sensitivity, there is a method of using a binder having a polymerizable group.

Meanwhile, a surface treatment material, in particular, a surface treatment material for forming a plating film is required to have a function to adsorb a plating catalyst. Although a carboxylic acid group, a hydroxyl group, an ether group and the like are commonly known as an adsorbent group to a plating catalyst, since these functional groups have high hydrophilicity and are apt to retain moisture, ions and the like, there is a fear that the change in the temperature and humidity dependency or the shape of a formed plating film is influenced.

As measures against such a fear, a method of using a cyano group as a functional group for achieving a good balance between the adsorptivity and the hydrophobicity to the plating catalyst is under consideration.

As the polymer which has such a cyano group and a polymerizable group, there are known polymers synthesized by anion polymerization by using the following monomers (for example, refer to Japanese Patent Application Laid-Open (JP-A) No. 11-106372: CH₂═C(CN)COOR¹OOCCH═CH₂ (R₁ represents a lower alkylene group).

In this synthetic method, anionic polymerization proceeds even with a trace amount of water, and there is a problem that handling is difficult.

Further, in consideration of producing a metallic pattern by using a surface treatment material having a plating film thereon, a resin material such as a polymer used for forming the surface treatment material is required to have resistance to hydrolysis due to an aqueous alkali solution, and hydrolysis under high pressure, high humidity and temperature conditions. However, a resin material which has a good balance the adsorptivity and the hydrophobicity to a plating catalyst, and resistance to hydrolysis due to an aqueous alkali solution has not yet been provided.

### SUMMARY OF THE INVENTION

The present invention has been made in view of the above circumstances and provides a novel copolymer, a composition containing the novel copolymer, a laminate body, a method of producing metal film-coated material, a metal film-coated material, a method of producing a metallic pattern and a metallic pattern.

According to a first aspect of the invention, there is provided a polymer containing a unit represented by the following Formula (1), and a unit represented by the following Formula (2):

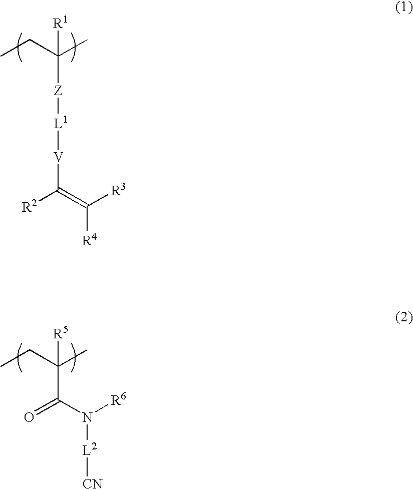

In Formula (1) and Formula (2), R¹ to R⁵ each independently represent a hydrogen atom, a substituted or unsubstituted alkyl group, R⁶ represents an unsubstituted alkyl group, an alkenyl group, an alkynyl group or an aryl group, V and Z each independently represent a single bond, an substituted or unsubstituted divalent organic group, an ester group, an amide group or an ether group, and L¹ and L² each independently represent a substituted or unsubstituted divalent organic group.

According to a second aspect of the invention, there is provided a composition containing the polymer of the invention, and a solvent which can dissolve the polymer.

According to a third aspect of the invention, there is provided a laminate body formed by coating the composition of the invention on a resin base material.

According to a fourth aspect of the invention, there is provided a method of producing a metal film-coated material including: forming a polymer layer by using a composition containing a polymer of the invention on a substrate; applying a plating catalyst or a precursor of the catalyst onto the polymer layer; and plating the plating catalyst or the precursor.

According to a fifth aspect of the invention, there is provided a metal film-coated material obtained by the method of producing the metal film-coated material of the invention.

According to a sixth aspect of the invention, there is provided a method of producing a metallic pattern-bearing material including pattern-wise etching the plating film of the metal film-coated material obtained by the method of producing the metal film-coated material of the invention.

According to a seventh aspect of the invention, there is provided a metallic pattern-bearing material obtained by the method of producing the metallic pattern-bearing material of the invention.

### DETAILED DESCRIPTION OF THE INVENTION

Hereinafter, thee invention is explained in detail.

[Novel Copolymer]

The novel copolymer of the invention is a copolymer containing the unit represented by Formula (1), and the unit represented by Formula (2).

Hereafter, the polymer of the invention may be referred to as “cyano group-containing polymerizable polymer”, and will be explained in detail.

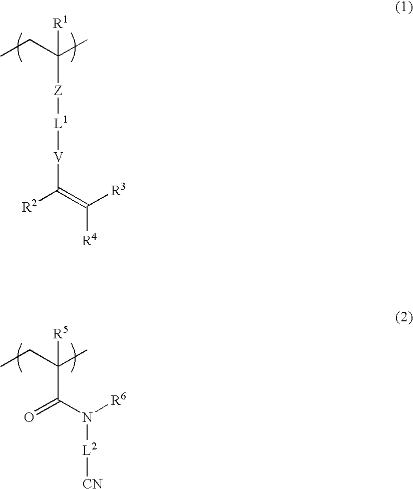

In Formula (1) and Formula (2), R¹ to R⁵ each independently represent a hydrogen atom, a substituted or unsubstituted alkyl group, R⁶ represents an unsubstituted alkyl group, an alkenyl group, an alkynyl group or an aryl group, V and Z each independently represent a single bond, a substituted or unsubstituted divalent organic group, an ester group, an amide group or an ether group, and L¹ and L² each independently represent a substituted or unsubstituted divalent organic group.

When R¹ to R⁵ each represent a substituted or unsubstituted alkyl group, examples of the unsubstituted alkyl group include, a methyl group, an ethyl group, a propyl group and a butyl group, and examples of the substituted alkyl group include a methyl group, an ethyl group, a propyl group and a butyl group, which are substituted with a methoxy group, a hydroxyl group, a chlorine atom, a bromine atom, a fluorine atom and the like.

Here, R¹ is preferably a hydrogen atom, a methyl group, or a methyl group substituted with a hydroxyl group or a bromine atom.

R² is preferably a hydrogen atom, a methyl group, or a methyl group substituted with a hydroxyl group or a bromine atom.

R³ is preferably a hydrogen atom.

R⁴ is preferably a hydrogen atom.

R⁵ is preferably a hydrogen atom, a methyl group, or a methyl group substituted with a hydroxyl group or a bromine atom.

R⁶ represents an unsubstituted alkyl group, an alkenyl group, an alkynyl group or an aryl group, and when R⁶ represents an unsubstituted alkyl group, an alkenyl group or an alkynyl group, these groups may have a branched structure.

The change in the quantity of the polymerizable group and the cyano group contained in 1 g of the polymer of the invention influences the effects exerted by the polymer of the invention. From this point of view, the total number of carbon atoms of an unsubstituted alkyl group, an alkenyl group, an alkynyl group or an aryl group represented by R⁶ is preferably in the following range.

When R⁶ represents an unsubstituted alkyl group, an alkenyl group, or an alkynyl group, the total number of carbon atoms of these groups is preferably 1 to 16, more preferably 1 to 10, and still more preferably 1 to 6.

When R⁶ represents an aryl group, the total number of carbon atoms of the aryl group is preferably 6 to 14, and more preferably 6 to 10.

It can be presumed that the enhancement of the hydrolysis suppression capability, which is the most outstanding feature of the polymer of the present invention, can be attained by including an amide bond in the unit represented by Formula (2) in the polymer of the invention. On the other hand, the presence of the amide group in the polymer may act to decrease the low water-absorptivity, which is another feature required for the polymer of the present invention; however, in the polymer of the present invention, it can be presumed that since a substituent represented by R⁶ is contained in the amide bond, R⁶ functions to shield and hydrophobize the amide bond from the outside. As a result, the polymer of the invention exhibits outstanding low water-absorptivity, while containing an amide bond in the polymer.

Since the hydrophobizing function with respect to the amide bond exhibited by the substituent represented by R⁶ is preferably exhibited when the amide bond is shielded by a structure having a smaller number of carbon atoms, it is preferable for R⁶ to be a substituent having a branched structure.

Specifically, examples of the substituent represented by R⁶ include a methyl group, an ethyl group, a propyl group, an isopropyl group, a butyl group, an isobutyl group, a t-butyl group, a pentyl group, an s-pentyl group, an isopentyl group, a cyclopentyl group, a hexyl group, a cyclohexyl group, a heptyl group, a cycloheptyl group, an octyl group, a nonyl group, a decanyl group, an ethylene group, an allyl group, an acetylene group, a phenyl group and the like.

As the substituent represented by R⁶, from the viewpoint of shielding the amide bond by a structure with a fewer number of carbon atoms, an alkyl group having a branched structure having a total number of carbon atoms of 3 to 6, and an aryl group having a total number of carbon atoms of 6 to 8 are preferred, and of these, a t-butyl group, a cyclohexyl group or a phenyl group is preferred as R⁶.

When V and Z each represent a substituted or unsubstituted divalent organic group, examples of the divalent organic group include a substituted or unsubstituted aliphatic hydrocarbon group, and a substituted or unsubstituted aromatic hydrocarbon group.

Preferable examples of the substituted or unsubstituted aliphatic hydrocarbon group include a methylene group, an ethylene group, a propylene group, a butylene group, and groups formed by substituting these groups with a methoxy group, a hydroxyl group, a chlorine atom, a bromine atom, a fluorine atom or the like.

Preferable examples of the substituted or unsubstituted aromatic hydrocarbon group include an unsubstituted phenyl group and a phenyl group substituted with a methoxy group, a hydroxyl group, a chlorine atom, a bromine atom, a fluorine atom or the like.

Of these, —(CH₂)ₙ— (wherein n is an integer from 1 to 3) is preferred, and —CH₂— is more preferred.

L¹ is preferably a divalent organic group having a urethane bond or a urea bond, more preferably a divalent organic group having a urethane bond, and in particular, a group having a total number of carbon atoms of 1 to 9 is preferred. Here, the total number of carbon atoms of L¹ means the total number of carbon atoms contained in the substituted or unsubstituted divalent organic group represented by L¹.

More specifically, the structure of L¹ is preferably a structure represented by the following Formula (1-1) or Formula (1-2):

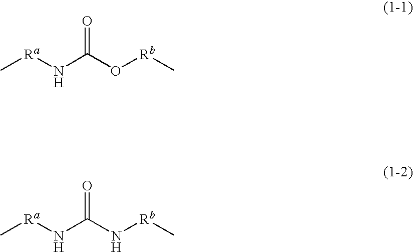

In Formula (1-1) and Formula (1-2), R^{a} and R^{b} each independently represent a divalent organic group formed by using two or more atoms selected from the group consisting of a carbon atom, a hydrogen atom and an oxygen atom, and preferable examples thereof include a methylene group, an ethylene group, a propylene group, a butylene group, an ethylene oxide group, a diethylene oxide group, a triethylene oxide group, a tetraethylene oxide group, a dipropylene oxide group, a tripropylene oxide group and a tetrapropylene oxide group, all of which may be substituted or unsubstituted.

A substituted or unsubstituted divalent organic group represented by L² is preferably a linear, branched or cyclic alkylene group, an aromatic group, or a group resulting from a combination of these groups. The group formed by combining an alkylene group and an aromatic group may further have an ether group, an ester group, an amide group, a urethane group or a urea group between the alkylene group and the aromatic group. Of these, L² is preferably a group having a total number of carbon atoms of 1 to 15, and particularly preferably an unsubstituted group. Here, the total number of carbon atoms of L² means the total number of carbon atoms contained in the substituted or unsubstituted divalent organic group represented by L².

Specifically, examples of the organic group represented by L² include a methylene group, an ethylene group, a propylene group, a butylene group, a phenylene group, and groups formed by substituting these groups with a methoxy group, a hydroxyl group, a chlorine atom, a bromine atom, a fluorine atom or the like, and further groups formed by combining these groups.

Further, the linking site with the cyano group in L² is preferably a divalent organic group having a linear, branched or cyclic alkylene group, in particular, the total number of carbon atoms of the divalent organic group is preferably from 1 to 10.

As another preferable exemplary embodiment, the linking site with the cyano group in L² is preferably a divalent organic group having an aromatic group, in particular, the total number of carbon atoms of the divalent organic group is preferably from 6 to 15.

As the cyano group-containing polymerizable polymer of the invention, the unit represented by Formula (1) is preferably a unit represented by the following Formula (3).

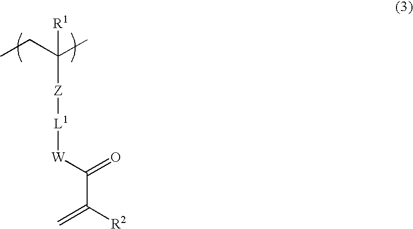

In Formula (3), R¹ and R² each independently represent a hydrogen atom, a substituted or unsubstituted alkyl group, Z represents a single bond, or a substituted or unsubstituted divalent organic group, an ester group, an amide group or an ether group, W represents an oxygen atom or NR(R represents a hydrogen atom, or an alkyl group, preferably a hydrogen atom or an unsubstituted alkyl group having 1 to 5 carbon atoms), and L¹ represents a substituted or unsubstituted divalent organic group.

R¹ and R² in Formula (3) have the same definitions as R¹ and R² in Formula (1), and the preferable examples thereof are also the same as those of Formula (1).

Z in Formula (3) has the same definitions as Z in Formula (1), and the preferable examples thereof are also the same as those of Z in Formula (1).

L¹ in Formula (3) has the same definitions as L¹ in Formula (1), and the preferable examples thereof are also the same as those of L¹ in Formula (1).

In the cyano group-containing polymerizable polymer of the invention, the unit represented by Formula (3) is preferably a unit represented by the following Formula (4);

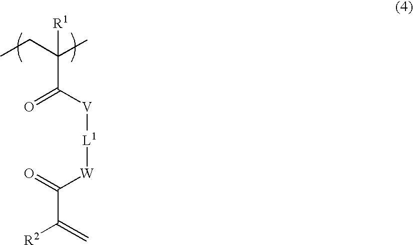

In Formula (4), R¹ and R² each independently represent a hydrogen atom, or a substituted or unsubstituted alkyl group; V and W each independently represent an oxygen atom, or NR (wherein, R represents a hydrogen atom or an alkyl group, and is preferably a hydrogen atom or an unsubstituted alkyl group having 1 to 5 carbon atoms); and L¹ represents a substituted or unsubstituted divalent organic group.

R¹ and R² in Formula (4) have the same definitions as R¹ and R² in Formula (1), and the preferable examples thereof are also the same as those of R¹ and R² in Formula (1).

L¹ in Formula (4) has the same definitions as L¹ in Formula (1), and the preferable examples thereof are also the same as those of L¹ in Formula (1).

In Formula (3) and Formula (4), W is preferably an oxygen atom.

In Formula (3) and Formula (4), L¹ is preferably an unsubstituted alkylene group, or a divalent organic group having a urethane bond or a urea bond, more preferably a divalent organic group having a urethane bond, and of these, a group having a total number of carbon atoms of 1 to 9 is particularly preferable.

The cyano group-containing polymerizable polymer of the invention is formed by containing the unit (hereinafter, referred to as a “polymerizable group-containing unit”, as needed) represented by Formula (1) and the unit (hereinafter, referred to as a “cyano group-containing unit”, as needed) represented by Formula (2), and is a polymer having a specific polymer containing the polymerizable group and the cyano group in the side chain of the polymer.

The cyano group-containing polymerizable polymer can be synthesized in the following manner, for example.

The polymerization reaction of the synthesis of the cyano group-containing polymerizable polymer is carried out by a radical polymerization.

Examples of the synthetic methods include (i) a method of copolymerizing cyano group-containing monomers with polymerizable group-containing monomers, (ii) a method of copolymerizing cyano group-containing monomers with double bond precursor-containing monomer, followed by treatment with a base or the like to introduce double bonds into the copolymer, and (iii) a method of copolymerizing cyano group-containing monomers with polymerizable group-containing monomers, thereby introducing double bonds (introducing polymerizable groups). From the viewpoint of synthetic suitability, preferable examples of the synthetic methods include (ii) a method of copolymerizing cyano group-containing monomers with double bond precursor-containing monomer, followed by treatment with a base or the like to introduce double bonds into the copolymer, and (iii) a method of copolymerizing cyano group-containing monomers with polymerizable group-containing monomers, thereby introducing polymerizable groups.

Examples of the monomer having a cyano group used in the synthetic method (i) include N-methyl-2-cyanoethyl(meth)acrylamide, N-methyl-1-cyanoethyl(meth)acrylamide, N-methyl-3-cyanopropyl(meth)acrylamide, N-methyl-p-cyanobenzyl(meth)acrylamide, N-ethyl-2-cyanoethyl(meth)acrylamide, N-ethyl-1-cyanoethyl(meth)acrylamide, N-ethyl-3-cyanopropyl(meth)acrylamide, N-ethyl-p-cyanobenzyl(meth)acrylamide, N-propyl-2-cyanoethyl(meth)acrylamide, N-propyl-1-cyanoethyl(meth)acrylamide, N-propyl-3-cyanopropyl(meth)acrylamide, N-propyl-p-cyanobenzyl(meth)acrylamide, N-n-butyl-2-cyanoethyl(meth)acrylamide, N-n-butyl-1-cyanoethyl(meth)acrylamide, N-n-butyl-3-cyanopropyl(meth)acrylamide, N-n-butyl-p-cyanobenzyl(meth)acrylamide, N-t-butyl-2-cyanoethyl(meth)acrylamide, N-t-butyl-1-cyanoethyl(meth)acrylamide, N-t-butyl-3-cyanopropyl(meth)acrylamide, N-t-butyl-p-cyanobenzyl(meth)acrylamide, N-hexyl-2-cyanoethyl(meth)acrylamide, N-hexyl-1-cyanoethyl(meth)acrylamide, N-hexyl-3-cyanopropyl(meth)acrylamide, N-hexyl-p-cyanobenzyl(meth)acrylamide, N-phenyl-2-cyanoethyl(meth)acrylamide, N-phenyl-1-cyanoethyl(meth)acrylamide, N-phenyl-3-cyanopropyl(meth)acrylamide, N-phenyl-p-cyanobenzyl(meth)acrylamide, N-naphthyl-2-cyanoethyl(meth)acrylamide, N-naphthyl-1-cyanoethyl(meth)acrylamide, N-naphthyl-3-cyanopropyl(meth)acrylamide, N-naphthyl-p-cyanobenzyl(meth)acrylamide, N-t-butyl-4-cyanobutyl(meth)acrylamide, N-t-butyl-5-cyanopentyl(meth)acrylamide and N-t-butyl-6-cyanohexyl(meth)acrylamide.

As the monomer having polymerizable monomers used in the synthetic method (i), an allyl(meth)acrylate and the following compounds are exemplified.

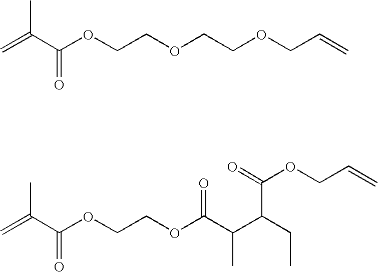

As the monomers having a double bond precursor used in the synthetic method (ii), the compounds represented by the following Formula (a) are exemplified:

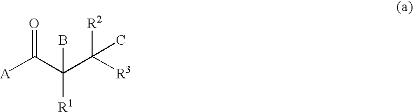

In Formula (a), A represents an organic group having a polymerizable group; R¹ to R³ each independently represent a hydrogen atom or a monovalent organic group; and B and C each represent a leaving group which is removed by an elimination reaction, and the elimination reaction as used herein means that C is drawn by the action of a base, and B is eliminated. It is preferable that B is eliminated as an anion, and C is eliminated as a cation.

As the compound represented by Formula (a), specifically the following compounds may be exemplified.

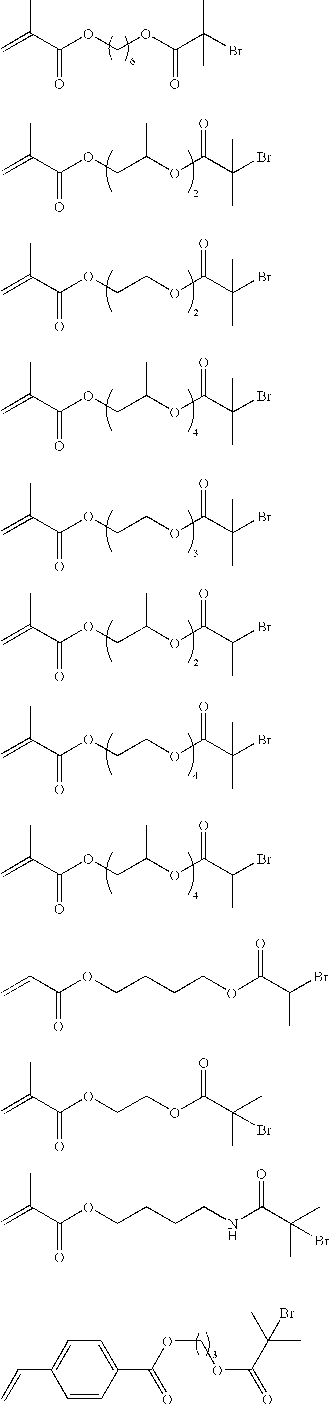

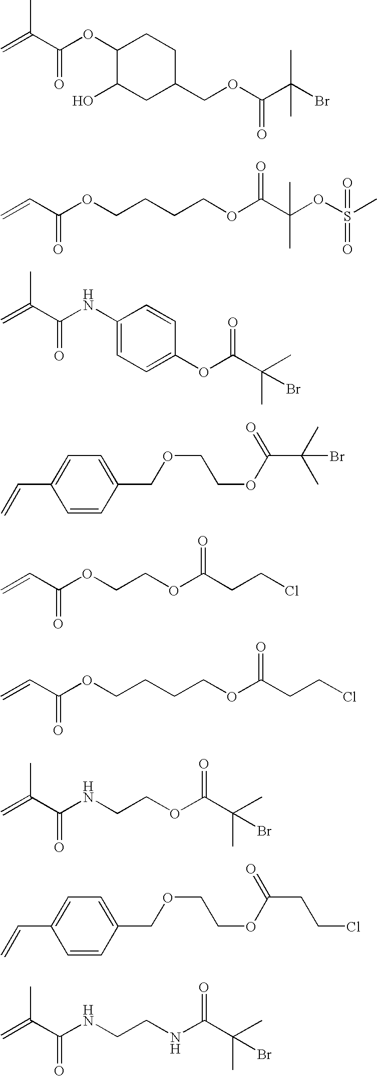

Further, in the synthetic method (ii), in order to convert the double bond precursor to the double bond, a method of removing the leaving groups represented by B and C through the elimination reaction as shown below, that is, a method of drawing C by the action of a base so that B is eliminated, is used.

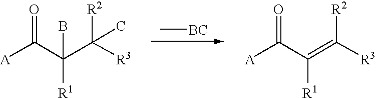

Preferable examples of the base used in the elimination reaction include hydrides, hydroxides or carbonates of alkali metals, organic amine compounds, and metal alkoxide compounds. Preferable examples of the hydrides, hydroxides or carbonates of alkali metals include sodium hydride, calcium hydride, potassium hydride, sodium hydroxide, potassium hydroxide, calcium hydroxide, potassium carbonate, sodium carbonate, potassium hydrogen carbonate, sodium hydrogen carbonate, and the like. Preferable examples of the organic amine compounds include trimethylamine, triethylamine, diethylmethylamine, tributylamine, triisobutylamine, trihexylamine, trioctylamine, N,N-dimethylcyclohexylamine, N,N-diethylcyclohexylamine, N-methyldicyclohexylamine, N-ethyldicyclohexylamine, pyrrolidine, 1-methylpyrrolidine, 2,5-dimethylpyrrolidine, piperidine, 1-methylpiperidine, 2,2,6,6-tetramethylpiperidine, piperazine, 1,4-dimethylpiperazine, quinuclidine, 1,4-diazabicyclo[2,2,2]-octane, hexamethylenetetramine, morpholine, 4-methylmorpholine, pyridine, picoline, 4-dimethylaminopyridine, lutidine, 1,8-diazabicyclo[5,4,0]-7-undecene (DBU), N,N′-dicyclohexylcarbodiimide (DCC), diisopropylethylamine, Schiff bases and the like. Preferable examples of the metal alkoxide compound include sodium methoxide, sodium ethoxide, potassium t-butoxide and the like. These bases may be used alone, or as a mixture of two or more kinds thereof.

Examples of the solvent used in the elimination reaction when a base is given (added), include ethylene dichloride, cyclohexanone, methyl ethyl ketone, acetone, methanol, ethanol, propanol, butanol, ethyleneglycol monomethylether, ethyleneglycol monoethylether, 2-methoxyethyl acetate, 1-methoxy-2-propanol, 1-methoxy-2-propylacetate, N,N-dimethylformamide, N,N-dimethylacetamide, dimethylsulfoxide, toluene, ethyl acetate, methyl lactate, ethyl lactate, water, and the like. These solvents may be used alone or as a mixture of two or more kinds thereof.

The amount of the base used may be an equivalent or less, or may also be an equivalent or more, relative to the amount of a specific functional group in the compound (leaving group represented by B or C). Furthermore, when an excess base is used, it is also preferred to add an acid or the like for the purpose of removing the excess base after the elimination reaction.

The polymer having a cyano group, which is used in the synthetic method (iii) in the above, is synthesized by radical-polymerizing a monomer which is used in the formation of the cyano group-containing monomer used in the synthetic method (i) and a monomer having a reactive group for introducing a double bond.

Examples of the monomer having the reactive group for introducing a double bond include the monomers having a carboxyl group, a hydroxyl group, an epoxy group or an isocyanate group as the reactive group.

Examples of the carboxyl group-containing monomer include (meth)acrylic acid, itaconic acid, vinyl benzoate; ARONIX M-5300, M-5400 and M-5600 (all trade names) manufactured by Toagosei Co., Ltd.; ACRYLESTER PA and HH (all trade names) manufactured by Mitsubishi Rayon Co., Ltd.; LIGHT ACRYLATE HOA-HH (trade name) manufactured by Kyoeisha Chemical Co., Ltd.; NK ESTER SA and A-SA (all trade names) manufactured by Shin-Nakamura Chemical Co., Ltd.; and the like.

Examples of the hydroxyl group-containing monomer include 2-hydroxyethyl(meth)acrylate, 4-hydroxybutyl(meth)acrylate, 2-hydroxypropyl(meth)acrylate, 2-hydroxybutyl(meth)acrylate, 1-(meth)acryloyl-3-hydroxy-adamantane, hydroxymethyl(meth)acrylamide, (2-hydroxyethyl)-(meth)acrylate, 3-chloro-2-hydroxypropyl(meth)acrylate, 3,5-dihydroxypentyl(meth)acrylate, 1-hydroxymethyl-4-(meth)acryloylmethyl-cyclohexane, 2-hydroxy-3-phenoxypropyl(meth)acrylate; ARONIX M-554, M-154, M-555, M-155, M-158 (all trade names) manufactured by Toagosei Co., Ltd.; BLENMER PE-200, PE-350, PP-500, PP-800, PP-1000, 70PEP-350B, 55PET800 (all trade names) manufactured by Nippon Oil & Fats Co., Ltd.; and lactone-modified acrylates having the following structure;

CH₂═CRCOOCH₂CH₂[OC(═O)C₅H₁₀]ₙOH

(wherein R═H or a methyl group, and n=1 to 5).

Examples of the monomer having an epoxy group include glycidyl(meth)acrylate, CYCLOMER A and M (all trade names) manufactured by Daicel Chemical Industries, Ltd., and the like.

Examples of the monomer having an isocyanate group include KARENZ AOI and MOI (all trade names) manufactured by Showa Denko K.K.

The polymer having a cyano group, which is used in the synthesis method of (iii), may further contain a third copolymerizable component.

In the synthesis method of (iii) above, although the monomer having a polymerizable group which is reacted with the polymer having a cyano group, varies with the type of the reactive group in the polymer having a cyano group, monomers having the following combinations of functional groups may be used.

That is, (reactive group of polymer, functional group of monomer)=(carboxyl group, carboxyl group), (carboxyl group, epoxy group), (carboxyl group, isocyanate group), (carboxyl group, benzyl halide), (hydroxyl group, carboxyl group), (hydroxyl group, epoxy group), (hydroxyl group, isocyanate group), (hydroxyl group, benzyl halide), (isocyanate group, hydroxyl group), (isocyanate group, carboxyl group), (epoxy group, carboxyl group), and the like may be exemplified.

Specifically, examples include the following monomers.

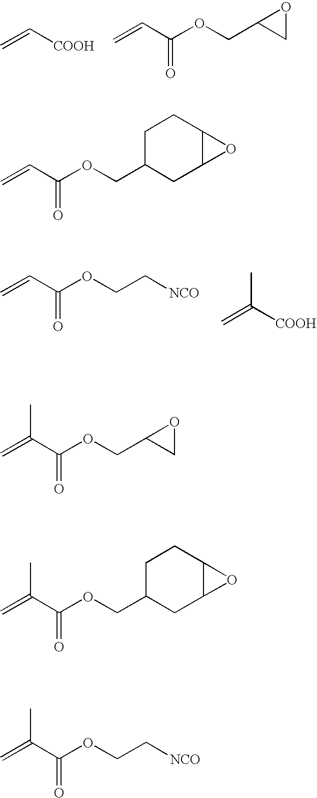

In the cyano group-containing polymerizable polymer of the invention, if L¹ in Formula (1), Formula (3) or Formula (4) has a structure of a divalent organic group having a urethane bond, it is preferable to synthesize the polymer by the synthesis method shown below (method of synthesizing the polymer of the invention).

It is preferable that the synthetic method of the polymer of the invention include the step in which a polymer having a hydroxyl group in the side chain, and a compound having an isocyanate group and a polymerizable group are used at least in a solvent, and a urethane bond is formed in L¹ by adding the isocyanate group to the hydroxyl group.

Here, preferable examples of the polymer having a hydroxyl group in the side chain, which is used in the synthetic method of the polymer of the invention, include the copolymers formed from the cyano group-containing monomers used in the synthetic method (i), and the hydroxyl group-containing (meth)acrylate as shown below.

Examples of the hydroxyl group-containing (meth)acrylate include 2-hydroxyethyl(meth)acrylate, 4-hydroxybutyl(meth)acrylate, 2-hydroxypropyl(meth)acrylate, 2-hydroxybutyl(meth)acrylate, 1-(meth)acryloyl-3-hydroxy-adamantane, hydroxymethyl(meth)acrylamide, 2-(hydroxymethyl)-(meth)acrylate, methyl ester of 2-(hydroxymethyl)-(meth)acrylate, 3-chloro-2-hydroxypropyl(meth)acrylate, 3,5-dihydroxypentyl(meth)acrylate, 1-hydroxymethyl-4-(meth)acryloylmethyl-cyclohexane, 2-hydroxy-3-phenoxypropyl(meth)acrylate, 1-methyl-2-acryloyloxypropyl phthalate, 2-acryloyloxyethyl-2-hydroxyethyl phthalate, 1-methyl-2-acryloyloxyethyl-2-hydroxypropyl phthalate, 2-acryloyloxyethyl-2-hydroxy-3-chloropropyl phthalate; ARONIX M-554, M-154, M-555, M-155, M-158 (all trade names) manufactured by Toagosei Co., Ltd.; BLENMER PE-200, PE-350, PP-500, PP-800, PP-1000, 70PEP-350B, 55PET800 (all trade names) manufactured by Nippon Oil & Fats Co., Ltd.; and lactone-modified acrylates having the following structure;

CH₂═CRCOOCH₂CH₂[OC(═O)C₅H₁₀]ₙOH

(wherein R═H or a methyl group, and n=1 to 5).

The polymer having a hydroxyl group in the side chain, which is used in the synthetic method of the polymer of the invention, may further contain a third copolymerizable component.

Among the polymers having a hydroxyl group in the side chain as described in the above, from the viewpoint of synthesizing a polymer having a high molecular weight, it is preferable to use the polymer synthesized by using a raw material, from which the bifunctional acrylate by-produced in the course of the synthesis of the hydroxyl group-containing (meth)acrylate is removed, as the raw material. As the method of purifying the hydroxyl group-containing (meth)acrylate, distillation and column purification are preferable. More preferably, a polymer synthesized by using the hydroxyl group-containing (meth)acrylate obtained by way of the following processes of (1) to (4) in sequence, is preferable:

(1) a process of dissolving a mixture containing a hydroxyl group-containing (meth)acrylate and the bifunctional acrylate which is by-produced in the course of the synthesis of the hydroxyl group-containing (meth)acrylate, in water;

(2) a process of adding a first organic solvent which is separated from water, into the obtained aqueous solution, and thereafter, separating a phase containing the first organic solvent and the bifunctional acrylate, from the water phase;

(3) a process of dissolving a compound having higher water-solubility than the hydroxyl group-containing (meth)acrylate, in the water phase; and

(4) a process of adding a second organic solvent to the water phase to extract the hydroxyl group-containing (meth)acrylate, and thereafter concentrating the extract.

The mixture used in the process (1) contains the hydroxyl group-containing (meth)acrylate and the bifunctional acrylate which is an impurity by-produced in the course of the synthesis of the hydroxyl group-containing (meth)acrylate, and thus, the mixture is equivalent to a commonly commercially available product of hydroxyl group-containing (meth)acrylate.

In the process (1), the commercially available product (mixture) is dissolved in water, and an aqueous solution is obtained.

In the process (2), the first organic solvent which is separated from water is added to the aqueous solution obtained in the process (1). Examples of the first organic solvent used herein include ethyl acetate, diethyl ether, benzene, toluene and the like.

Thereafter, the phase (oil phase) containing this first organic solvent and the bifunctional acrylate is separated from the aqueous solution (water phase).

In the process (3), a compound having higher water-solubility than the hydroxyl group-containing (meth)acrylate is dissolved in the water phase separated from the oil phase in the process (2).

As the compound having higher water-solubility than the hydroxyl group-containing (meth)acrylate as used herein, inorganic salts which include alkali metal salts such as sodium chloride or potassium chloride; alkaline earth metal salts such as magnesium sulfate or calcium sulfate; and the like may be used.

In the process (4), the second organic solvent is added to the water phase to extract the hydroxyl group-containing (meth)acrylate, and thereafter, the extract is concentrated.

Examples of the second organic solvent used herein include ethyl acetate, diethyl ether, benzene, toluene and the like. This second organic solvent may be identical to the first organic solvent, or may also be different from the first organic solvent.

In the concentration in the process (4), drying with anhydrous magnesium sulfate, distillation off under reduced pressure or the like is used.

The isolated product containing the hydroxyl group-containing (meth)acrylate obtained by way of the processes (1) to (4) in sequence, preferably contains the bifunctional acrylate in an amount of 0.1% by mass or less of the total mass. That is, by way of the processes (1) to (4), the bifunctional acrylate which is an impurity is removed from the mixture, and thus the hydroxyl group-containing (meth)acrylate is purified.

A more preferable range of the content of the bifunctional acrylate is 0.05% by mass or less relative to the total mass of the isolated product, and the smaller content is the better.

When the hydroxyl group-containing (meth)acrylate thus purified is used, the bifunctional acrylate which is an impurity does not easily influence the polymerization reaction, and thus the cyano group-containing polymerizable polymer having a weight average molecular weight of 20,000 or more can be synthesized.

As the hydroxyl group-containing (meth)acrylate used in the process (1), those previously recited as the hydroxyl group-containing (meth)acrylate which is used at the time of synthesizing the polymer having a hydroxyl group in the side chain in the synthetic method of the polymer of the invention, may be used. Of these, from the viewpoint of the reactivity with isocyanate, a monomer having a primary hydroxyl group is preferred, and furthermore, from the viewpoint of increasing the ratio of the polymerizable group per unit weight of the polymer, the hydroxyl group-containing (meth)acrylate having a molecular weight of 100 to 250 is preferred.

As the compound having an isocyanate group and a polymerizable group, which is used in the synthetic method of the polymer of the invention, 2-acryloyloxyethyl isocyanate (trade name: KARENZ AOI; manufactured by Showa Denko K.K.), 2-methacryloxy isocyanate (trade name: KARENZ MOI; manufactured by Showa Denko K.K.) and the like, may be exemplified.

Further, examples of the solvent used in the synthetic method of the polymer of the invention include ethyleneglycol diacetate, diethyleneglycol diacetate, propyleneglycol diacetate, methyl acetoacetate, ethyl acetoacetate, 1,2,3-triacetoxy-propane, cyclohexanone, 2-(1-cyclohexenyl)cyclohexanone, propionitrile, N-methylpyrrolidone, dimethylacetamide, acetylacetone, acetophenone, triacetin, 1,4-dioxane, dimethyl carbonate and the like.

In the cyano group-containing polymerizable polymer of the invention thus synthesized, it is preferred that the ratio of the polymerizable group-containing unit or the cyano group-containing unit to the total amount of copolymerizable components be in the following ranges.

That is, the polymerizable group-containing unit is preferably contained in an amount of 5% by mole to 50% by mole, and more preferably 5% by mole to 40% by mole, relative to the total amount of copolymerizable components. If the amount is less than 5% by mole, the reactivity (curability and polymerizability) is deteriorated, while if the amount exceeds 50% by mole, the polymer is easily gelated during the synthesis, resulting in difficulty in the synthesis.

The cyano group-containing unit is preferably contained in an amount in the range of 5% by mole to 95% by mole, and more preferably in the range of 10% by mole to 95% by mole, relative to the total amount of copolymerizable components from the viewpoint of the adsorptivity to a plating catalyst or the like.

The cyano group-containing polymerizable polymer of the invention may further contain another unit, in addition to the cyano group-containing unit and the polymerizable group-containing unit. As for the monomer used for forming another unit, any monomer may be used, provided that the monomer does not impair the effects of the invention.

However, in the case of introducing the polymerizable group into the polymer by allowing to the polymerizable group react with the polymer as described in the above, if the introduction at the ratio of 100% is difficult, a small amount of the reactive moieties may remain, and there is a possibility that the remained moieties may serve as a third unit.

Specifically, examples of the monomer to form other units include unsubstituted (meth)acrylates such as ethyl(meth)acrylate, butyl(meth)acrylate, hexyl(meth)acrylate, 2-ethylhexyl(meth)acrylate, cyclohexyl(meth)acrylate, benzyl(meth)acrylate or stearyl (meth)acrylate; halogen-substituted (meth)acrylates such as 2,2,2-trifluoroethyl(meth)acrylate, 3,3,3-trifluoropropyl(meth)acrylate or 2-chloroethyl(meth)acrylate; ammonium group-substituted (meth)acrylates such as 2-(meth)acryloyloxyethyl trimethylammonium chloride; (meth)acrylamides such as butyl(meth)acrylamide, isopropyl(meth)acrylamide, octyl(meth)acrylamide, 2-ethylhexylacrylamide, dimethyl(meth)acrylamide and 2-hydroxyethyl(meth)acrylamide; styrenes such as styrene, 4-hydroxystyrene, vinylbenzoic acid or p-vinylbenzylammonium chloride; vinyl compounds such as N-vinylcarbazole, vinyl acetate, N-vinylacetamide or N-vinylcaprolactam; and also, dimethylaminoethyl(meth)acrylate, diethylaminoethyl(meth)acrylate, 2-ethylthio-ethyl(meth)acrylate, (meth)acrylic acid, 2-hydroxyethyl(meth)acrylate, and the like.

Further, acrylamide derivatives represented by the following Formula (b) and a cyano group-containing monomer represented by the following Formula (c) may be used. By the use of these monomers, the physical properties can be controlled, without deteriorating absorptivity of the polymers. By introducing the former, the hydrophobicity can be imparted to the polymer, and by introducing the latter, the cured film can be flexible.

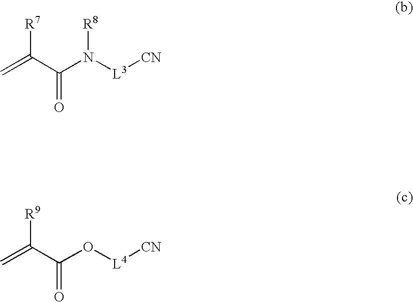

R⁷ in Formula (b) has the same definition as R¹ in Formula (1). L³ has the same definition as L² in Formula (2). R⁸ represents a halogen atom, an alkyl group substituted by a siloxy structure, an alkenyl group, an alkynyl group, an aryl group, or a group represented by -L⁵-CN. Here, L⁵ represents a divalent organic group having 4 or more carbon atoms.

R⁹ in Formula (b) has the same definition as R¹ in Formula (1). L⁴ has the same definition as L² in Formula (2).

Further, from the viewpoint of the influence on the polymerizability, and the balance of hydrophilicity and hydrophobicity, when the unit represented by Formula (b) or Formula (c) is added, the unit is preferably contained in an amount of from 5% by mole to 50% by mole, more preferably in an amount of from 10% by mole to 30% by mole with respect to the total amount of the copolymerizing components.

Further, as a monomer used for forming other units, a monomer, in which a substituent having a fluorine atom (for example, a fluorinated alkyl group, a fluorinated aryl group and the like) or a substituent having Si—O—Si bond is further introduced into the monomer used for forming the cyano group-containing unit, may be used.

The weight average molecular weight of the cyano group-containing polymerizable polymer of the invention is preferably from 1,000 to 700,000, and more preferably from 2,000 to 200,000. In particular, from the viewpoint of the polymerization sensitivity, the weight average molecular weight of the cyano group-containing polymerizable polymer of the invention is preferably 20,000 or more.

As for the degree of polymerization of the cyano group-containing polymerizable polymer of the invention, it is preferable to use a polymer of 10-mers or more, and more preferable to use a polymer of 20-mers or more. Furthermore, a polymer is preferably 7000-mers or less, more preferably 3000-mers or less, even more preferably 2000-mers or less, and particularly preferably 1000-mers or less.

Specifically, examples of the cyano group-containing polymerizable polymer of the invention are shown below, but the examples are not intended to be limited thereto.

The weight average molecular weights of these specific examples are all in the range of 3,000 to 100,000.

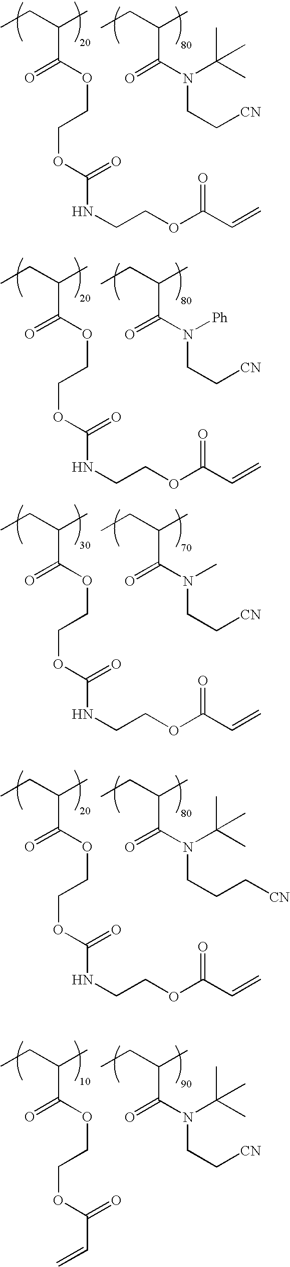

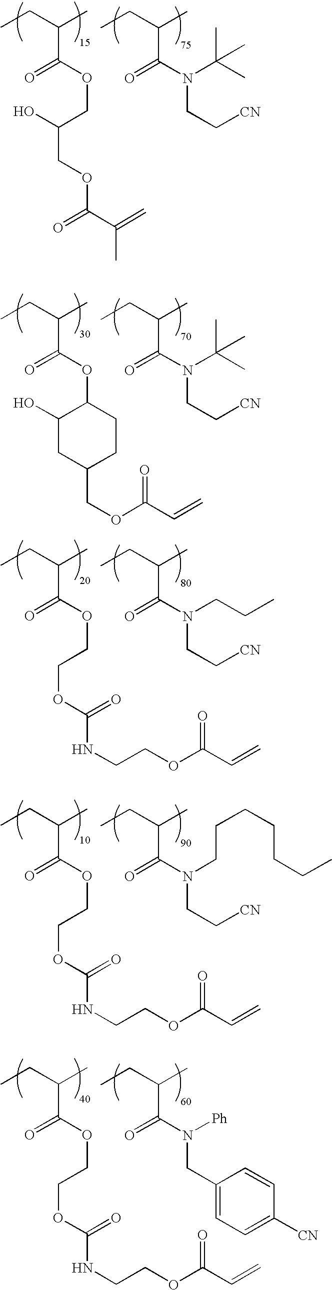

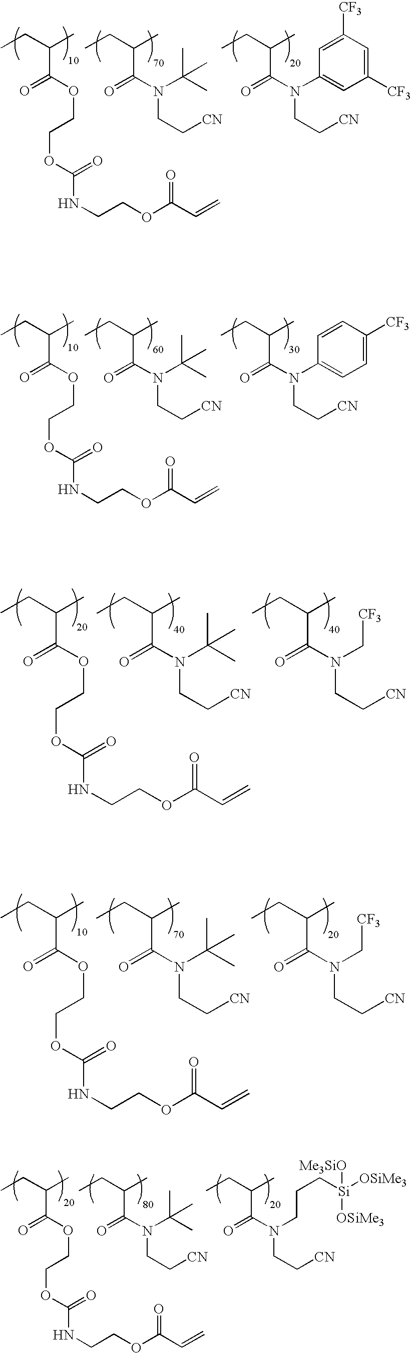

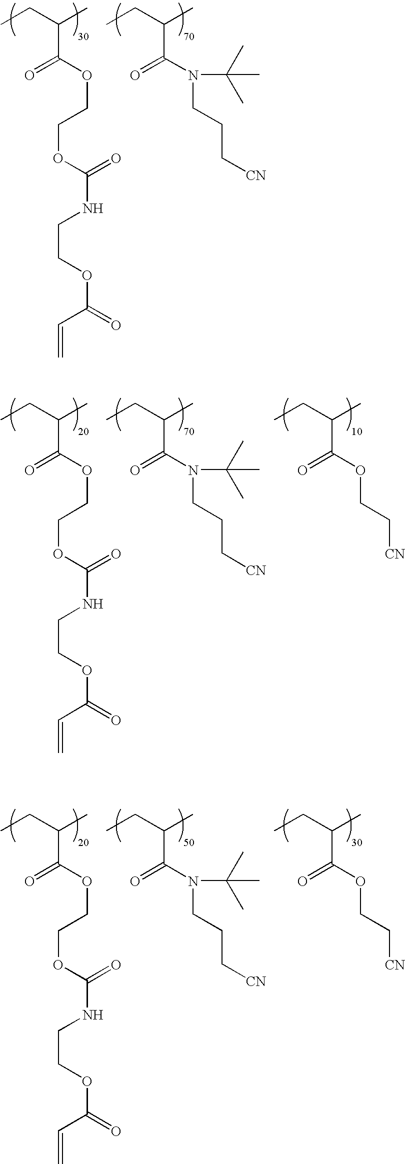

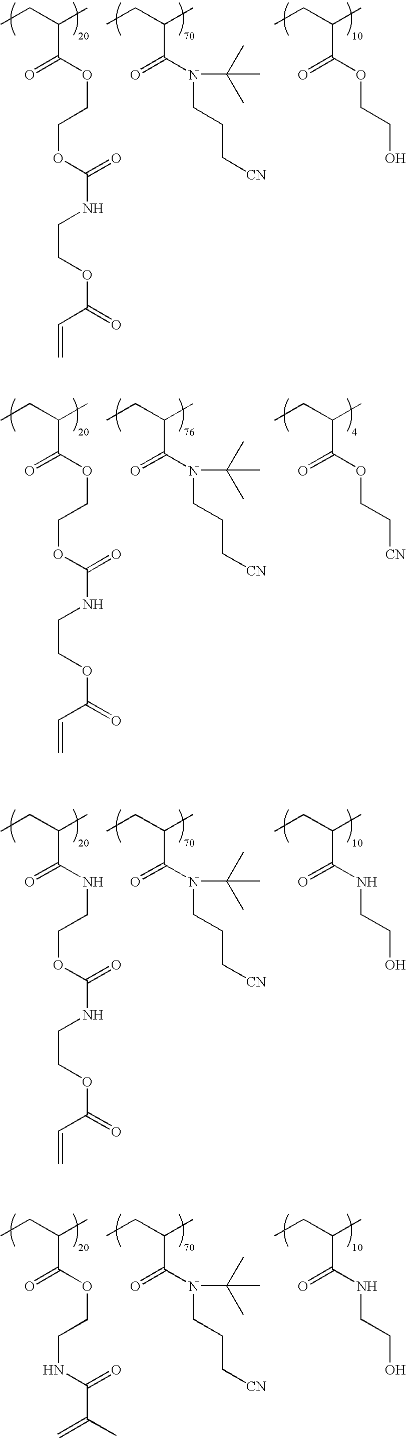

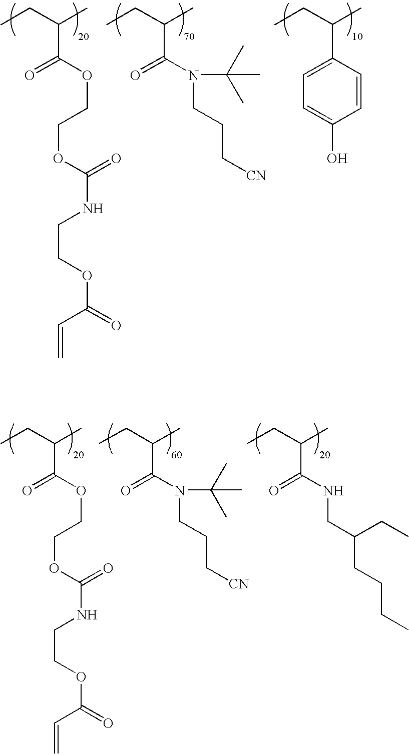

The cyano group-containing polymerizable polymer according to the invention, may also have a polar group in addition to the polymerizable group and an interactive group (cyano group).

For example, when the cyano group-containing polymerizable polymer of the invention is added to an alkaline solution having a pH value of 12, and the resultant solution is stirred for one hour, if the decomposition of the polymerizable group site is 50% or less, the polymer can be washed with a highly alkaline solution.

<Mode of Usage>

Since the cyano group-containing polymerizable polymer of the invention is a copolymer of a unit having a cyano group and a unit having a polymerizable group, by changing the ratio of the units, the adsorptivity to the metal of a plating catalyst or the like and the polymerizability (reactivity) may be controlled.

Such a cyano group-containing polymerizable polymer of the invention may be used in photocurable resin compositions, as well as in the electronic field, mechanical field, food field, construction field and automobile field, as a molding material, a coating material, a surface modifying material or a material for substrate.

Among the various applications, from the viewpoint of excellent adsorptivity to a plating catalyst and polymerizability despite being hydrophobic, the cyano group-containing polymer of the invention is preferably used as a surface treatment material for forming a plating film.

For example, when the cyano group-containing polymerizable polymer of the invention is directly chemically bonded to a desired base material by using the surface graft polymerization method or the like, a polymer layer having high adhesiveness to the base material, excellent adsorptivity to a plating catalyst, and low water absorbability, may be formed. A plating film, which is formed by applying a plating catalyst onto this polymer layer, followed by subjecting a plating treatment, has an effect of providing excellent adhesiveness to the polymer layer, as well as an effect that the polymer layer does not show any changes in the temperature/humidity dependency or the shape because the polymer layer hardly retains moisture or ions.

Further, in some application modes of the cyano group-containing polymerizable polymer of the invention, for example, in the case where an aqueous alkaline solution is used in the etching process and the like for forming a metallic pattern, the polymer layer formed by using the cyano group-containing polymerizable polymer of the invention can exert an effect on suppression of alkali hydrolysis, while maintaining low water-absorptivity.

In particular, in the case where a base material having this plating film formed thereon is used in the production of electrical wiring or the like, an excellent effect on inter-wiring insulation reliability can also achieved.

As for the base material having a plating film formed thereon, it is preferable to use a resin base material containing an epoxy resin, a polyimide resin or a PET resin.

The cyano group-containing polymerizable polymer may be mixed with other components such as a solvent and used as a composition (composition of the invention). In this case, the content of the cyano group-containing polymerizable polymer of the invention is preferably in the range of 2% by mass to 50% by mass, and more preferably in the range of 5% by mass to 30% by mass.

The solvent used in the composition of the invention is not particularly limited as long as the polymer is soluble therein. Further, surfactants may also be added to the solvent.

Examples of the solvent which can be used, include alcohol-based solvents such as methanol, ethanol, propanol, ethyleneglycol, glycerin or propyleneglycol monomethylether; acids such as acetic acid; ketone-based solvents such as acetone, methyl ethylketone or cyclohexanone; amide-based solvents such as formamide, dimethyl acetamide or N-methyl pyrrolidone; nitrile-based solvents such as acetonitrile or propylonitrile, ester-based solvents such as methyl acetate or ethyl acetate; carbonate-based solvent such as dimethyl carbonate or diethyl carbonate, and ether-based solvents, glycol-based solvents, amine-based solvents, thiol-based solvents and halogen-based solvents.

Of these solvents, in the case of preparing a composition using the cyano group-containing polymerizable polymer, amide-based, ketone-based, nitrile-based solvents and carbonate-based solvents are preferred, and specifically, acetone, dimethylacetamide, methyl ethylketone, cyclohexanone, acetonitrile, propionitrile, N-methylpyrrolidone and dimethyl carbonate are preferred.

When the composition containing a cyano group-containing polymerizable polymer of the invention is used for a coating liquid, a solvent having a boiling point of 50° C. to 150° C. is preferred from the viewpoint of easy handling. In addition, these solvents may be used alone, or may also be used as mixtures.

—Water-Soluble Organic Solvent—

In the composition of the invention, water can also be used as a solvent. In addition, it is desirable to use together water and a water-soluble organic solvent as a solvent, in consideration of inflammability at the time of drying, and, in that case, the content of the organic solvent is preferably from 0.1% by mass % to 40% by mass relative to all the solvents. Here, the water-soluble organic solvent means a solvent miscible with water in the above content range. The water-soluble organic solvent is not specifically limited as long as the organic solvent has such a property, and can be used as the solvent for the composition. As the water-soluble organic solvent, for example, ketone-based solvents, ester-based solvents, alcohol-based solvents, ether-based solvents, amine-based solvents, thiol-based solvents, halogen-based solvent and the like are preferably used.

Examples of the ketone-based solvents include 4-hydroxy-4-methyl-2-pentanone, γ-butyrolactone and hydroxyacetone. Examples of the ester-based solvents include 2-(2-ethoxyethoxy)ethylacetate, ethyleneglycol monomethylether acetate, diethyleneglycol monoethylether acetate, methyl cellosolve acetate, 2-hydroxyethyl acrylate, hydroxypropyl acrylate, methyl glycolate and ethyl glycolate.

Examples of the alcohol-based solvents include methanol, ethanol, isopropyl alcohol, n-propyl alcohol, 3-acetyl-1-propanol, 2-(allyloxy)ethanol, 2-aminoethanol, 2-amino-2-methyl-1-propanol, (±)-2-amino-1-propanol, 3-amino-1-propanol, 2-dimethylaminoethanol, 2,3-epoxy-1-propanol, ethyleneglycol, 2-fluoroethanol, diacetone alcohol, 2-methylcyclohexanol, 4-hydroxy-4-methyl-2-pentanone, glycerin, 2,2′,2″-nitrilotriethanol, 2-pyridinemethanol, 2,2,3,3-tetrafluoro-1-propanol, 2-(2-aminoethoxy)ethanol, 2-[2-(benzyloxy)ethoxy]ethanol, 2,3-butanediol, 2-butoxyethanol, 2,2′-thiodiethanol, 1,3-butanediol, 1,4-butanediol, 2,3-butanediol, 2-methyl-2,4-pentanediol, 1,3-propanediol, diglycerin, 2,2′-methyliminodiethanol and 1,2-pentanediol.

Examples of the ether-based solvents include bis(2-ethoxyethyl)ether, bis[2-(2-hydroxyethoxy)ethyl]ether, 1,2-bis(2-methoxyethoxy)ethane, bis[2-(2-methoxyethoxy)ethyl]ether, bis(2-methoxyethyl)ether, 2-(2-butoxyethoxy)ethanol, 2-[2-(2-chloroethoxy)ethoxy]ethanol, 2-ethoxyethanol, 2-(2-ethoxyethoxy)ethanol, 2-isobutoxyethanol, 2-(2-isobutoxyethoxy)ethanol, 2-isopropoxyethanol, 2-[2-(2-methoxyethoxy)ethoxy]ethanol, 2-(2-methoxyethoxy)ethanol, 1-ethoxy-2-propanol, 1-methoxy-2-propanol, tripropyleneglycol monomethylether, methoxy acetic acid and 2-methoxy ethanol.

Examples of the glycol-based solvents include diethylene glycol, triethylene glycol, ethylene glycol, hexaethylene glycol, propylene glycol, dipropylene glycol and tripropylene glycol.

Examples of the amine-based solvents include N-methyl-2-pyrrolidone and N,N-dimethyl formamide.

Examples of the thiol-based solvents include mercapto acetic acid and 2-mercapto ethanol.

Examples of the halogen-based solvents include 3-bromobenzyl alcohol, 2-chloroethanol and 3-chloro-1,2-propanediol.

In addition, as the water-soluble solvents, the solvents listed in the following Table 1 may be used.

TABLE 1

| acrylic acid | 2-(dimethylamino)ethyl acrylate | acetyl methylcarbinol |
|---|---|---|
| 1-amino-4-methylpiperazine | 3-aldehydepyridine | isobutyric acid |
| aluminum ethylacetate diisopropylate (water soluble) | | ethylglycol |
| ethyleneglycol monobutylether | ethylenechlorohydrin | N-ethylmorpholine |
| ethylenediamine | 3-ethoxypropylamine | formic acid (86% or more) |
| isoamyl formate | acetic acid | 1,4-diaminobutane |
| 1,2-diaminopropane | 1,3-diaminopropane | 3-diethylaminopropylamine |
| N,N-diethylethanolamine | cyclohexylamine | N,N-dimethylacetamide |
| di-n-butoxy-bis(triethanolaminato)titanium | | dimethylaminopropylamine |
| 2-dimethylaminoacetoaldehyde dimethylacetal | | N,N-dimetylethanolamine |
| 2,5-dimethylpyrazine | dalmatian pyrethrum (stored grain × | hydrated hydrazine (79% |
| | emulsion) | or less product) |
| sodium alcoholate (liquid) | tetramethyl-1,3-diaminopropane | sodium methoxide |
| 1,1,3-trihydrotetrafluoro- | ethyl lactate | methyl lactate |
| propanol | | |
| α-picoline | β-picoline | γ-picoline |
| hydrazine (79% or less product) | propionic acid | propylene chlorohydrin |
| benzylaminopurine (3% | trimethyl borate | methylaminopropyl amine |
| emulsion) | | |
| N-methylpiperazine | 2-methylpyrazine | 3-methoxypropylamine |
| 2-mercaptoethanol | morpholine | diethylenetriamine |
| N,N-dimethylacrylamide | dimethylaminopropyl | dimethylsulfoxide |
| | methacrylamide | |
| N,N-dimethylamino- | | (−)-D-isopropyltartrate |
| propylacrylamide | | |
| hydrated hydrazine (80% or | sulfolane (anhydrous product is a | thioglycolic acid |
| more product) | solid and nonhazardous material) | |
| thiodiglycol | tetraethylene pentamine | n-tetradecane |
| N,N,N′,N′-tetramethyl-1,6-hexamethylenediamine | | trimethyl phosphate (TEP) |
| triethylene glycol | triethylene tetramine | trimethyl phosphate |
| d-valerolactone | bisaminopropyl piperazine | hydrazine (80% or more |
| | | product) |
| 2-hydroxyethyl acrylate | 2-hydroxyethyl aminopropylamine | hydroxyethyl piperazine |
| 4-hydroxy-2-butanone | vinyl tris(β-methoxyethoxy)silane | 2-pyridine methanol |
| 3-pyridine methanol | 4-pyridine methanol | pyruvic acid |
| phenethyl amine | formamide | 1,3-butanediol |
| 1,4-butanediol | butyldiglycol | γ-butyrolactone |
| furfuryl alcohol | hexylene glycol | benzylamine |
| pentaethylene hexamine | polyethyleneglycol diglycidylether (n = 13 or less) | |
| polypropyleneglycol diglycidylether (n = 11 or less) | | methacrylic acid |
| 2-hydroxyethyl methacrylate | methylimino bispropylamine | N-methyl ethanolamine |
| N-methyl-N,N-dimethanolamine | 3-methyl-3-methoxybutylacetate | β-mercapto propionic acid |
| ethyleneglycol monoacetate | | |

From the viewpoint of the ease of evaporation, the boiling point of the water-soluble organic solvent of the invention is preferably from 70° C. to 150° C., and more preferably from 70° C. to 110° C. As such a water-soluble organic solvent, for example, ethanol (boiling point: 78° C.), isopropyl alcohol (boiling point: 82° C.), n-propyl alcohol (boiling point: 97° C.), and the like may be preferably exemplified.

Further, as described above, when a mixed-solution of water and a water-soluble organic solvent is used, from the viewpoint of the ease of work, the flash point of the solution is preferably 30° C. or more, more preferably 40° C. or more, and still more preferably 60° C. or more.

In addition, the flash point in the invention means the measured value obtained by a method according to Tag closed cup method as stipulated in JIS-K2265.

—Water—

It is preferable that water used in the composition of the invention do not contain impurities, and RO water, deionized water, distilled water, purified water and the like are preferred, and deionized water and distilled water are more preferred.

When the composition of the invention is coated on a resin base material to form a laminate body (laminate body of the invention), a solvent may be selected such that the solvent absorption rate of the base material is 5% to 25%. This solvent absorption rate may be determined from the change in the mass obtained when the base material is immersed in a solvent and pulled up at 1,000 minutes after the start of the immersion.

When the composition of the invention is coated on a base material, solvent may also be selected such that the swelling rate of the base material is 10% to 45%. This swelling ratio can be determined from the change in the thickness obtained when the base material is immersed in a solvent and pulled up at 1,000 minutes after the start of the immersion.

The surfactant which may be added to the composition as needed, may be any surfactant that is soluble in the solvent. Examples of the surfactant include anionic surfactants such as sodium n-dodecylbenzenesulfonate; cationic surfactants such as n-dodecyltrimethylammonium chloride; nonionic surfactants such as polyoxyethylene nonylphenol ether (examples of commercially available products include EMULGEN 910 (trade name); manufactured by Kao Corporation, and the like), polyoxyethylene sorbitan monolaurate (examples of commercially available products include “TWEEN 20” (trade name), and the like), and polyoxyethylene lauryl ether; and the like.

A plasticizer may also be added to the composition of the invention, as needed. As for the plasticizer that can be used, general plasticizers may be used, and examples of the plasticizers include phthalic acid esters (dimethyl ester, diethyl ester, dibutyl ester, di-2-ethylhexyl ester, di-normal-octyl ester, diisononyl ester, dinonyl ester, diisodecyl ester, butylbenzyl ester), adipic acid esters (dioctyl ester, diisononyl ester), dioctyl azelate, sebacic acid esters (dibutyl ester, dioctyl ester), tricresyl phosphate, tributyl acetylcitrate, epoxidated soybean oil, trioctyl trimellitate, chlorinated paraffins, and high boiling point solvents such as dimethylacetamide or N-methylpyrrolidone.

A polymerization inhibitor may be added to the composition of the invention, as needed. Examples of the polymerization inhibitor that may be used include hydroquinones such as hydroquinone, di-tertiary-butylhydroquinone and 2,5-bis(1,1,3,3-tetramethylbutyl)hydroquinone; phenols such as p-methoxyphenol and phenol; benzoquinones; free radicals such as TEMPO (2,2,6,6-tetramethyl-1-piperidinyloxy free radical) and 4-hydroxy-TEMPO; phenothiazines; nitrosoamines such as N-nitrosophenylhydroxyamine and aluminum salt thereof; and catechols.

A curing agent and/or curing accelerator may be added to the composition of the invention, if necessary. As for the curing agent and curing accelerator, known products may be used.

In addition, rubber components (for example, CTBN), flame retardants (for example, phosphorus-based flame retardants), diluents or thixotropic agents, pigments, defoaming agents, leveling agents, coupling agents and the like may also be added to the composition of the invention.

As in the composition of the invention, when a composition formed by appropriately mixing such a cyano group-containing polymerizable polymer and various additives is used, the physical properties of the cured product such as a polymer layer, which will be described later, formed by applying energy to the cyano group-containing polymerizable polymer, for example, the thermal expansion coefficient, glass transition temperature, Young's modulus, Poisson's ratio, rupture stress, yield stress, thermal decomposition temperature and the like, may be set at an optimal values. Particularly, it is preferable that the rupture stress, yield stress and thermal decomposition temperature be higher.

With regard to the cured product obtained by using the composition of the invention, thermal durability may be measured by a temperature cycle test or a thermal aging test, a reflow test or the like.

As the base material used in the formation of a laminate body by using the composition of the invention, a dimensionally stable plate-shaped object is preferred, and any material may be used as long as the material satisfies the required flexibility, strength, durability or the like, and may be appropriately selected according to the intended use.

Specifically, for example, a product obtained by molding a polyimide resin, a bismaleimide resin, a polyphenylene oxide resin, an epoxy resin, a liquid crystalline polymer, a polytetrafluoroethylene resin or the like, or a silicon substrate, paper, a paper laminated with a plastic, a metal plate (for example, aluminum zinc, copper or the like), a paper or plastic film laminated or deposited with a metal as described above, or the like may be exemplified.

In addition, as described above, in the case where a plating film is formed using the cyano group-containing polymerizable polymer on a base material, and this plating film is applied to the production of a printed-wiring board, it is preferable to use a base material formed from an insulating resin.

[Method of Producing Metal Film-Coated Material and Method of Producing Metallic Pattern-Bearing Material]

The method of producing the metal film-coated material of the invention includes a process (a1) of forming a polymer layer by directly bonding the cyano group-containing polymerizable polymer onto a substrate, a process (a2) of applying a plating catalyst or a precursor of the catalyst to the polymer layer, and a process (a3) of plating the plating catalyst or the precursor of the catalyst.

Further, the method of producing metallic pattern-bearing material of the invention includes a process (a4) of pattern-wise etching the plating film of the metal film-coated material obtained by the method of producing the metal film-coated material.

That is, in the method of producing metallic pattern-bearing material, after processes of (a1), (a2) and (a3) are performed in the method of producing the metal film-coated material, a process (a4) of pattern-wise etching the formed plating film is performed.

Hereinafter, each of process (a1) to (a3) in the method of producing the metal film-coated material of the invention is explained.

[Process (a1)]

In the process (a1) in a method of producing the metal film-coated material of the invention, a polymer layer is formed on a substrate by using the composition containing the cyano group-containing polymerizable polymer of the invention. The polymer in the formed polymer layer is the polymer originating from the cyano group-containing polymerizable polymer of the invention, and in a preferred exemplary embodiment, the polymer is directly chemically bonded to the substrate.

The process (a1) is preferably performed by applying the composition of the invention onto the substrate.

In another preferred exemplary embodiment, the process (a1) includes: (a1-1) producing a substrate having a polymerization initiation layer which contains a polymerization initiator or has a functional group capable of initiating polymerization, formed on a base material; and (a1-2) forming, on the polymerization initiation layer, a polymer layer by using the cyano group-containing composition of the invention.

The process (a1-2) is preferably a process of forming a polymer layer by directly chemically bonding the above polymer to the entire substrate surface (the entire surface of the polymerization initiation layer), by bringing the composition containing the cyano group-containing polymer of the invention into contact with the surface of the polymerization initiation layer, followed by applying energy thereto.

(Surface Grafting)

In the formation of a polymer layer on a substrate, a technique generally called surface graft polymerization is used. Graft polymerization is a method of synthesizing a graft polymer by giving an active species on a polymer compound chain, and further polymerizing another monomer, the polymerization of which is initiated by the active species. In particular, in the case where the polymer compound giving an active species forms a solid surface, the method is referred to as surface graft polymerization.

As the surface graft polymerization method applicable to the invention, all the known methods described in literatures may be used. For example, photograft polymerization methods and plasma irradiation-induced graft polymerization methods are described as the surface graft polymerization method, in New Polymer Experimentology, Vol. 10, edited by the Society of Polymer Science, Japan, published by Kyoritsu Shuppan Co., Ltd., p., 135 (1994). Furthermore, radiation ray irradiation-induced graft polymerization methods using γ-ray, electron beam or the like are described in Handbook of Adsorption Technology, NTS Co., Ltd., reviewed by Takeuchi, published in February, 1999, pp., 203 and 695.

As specific examples of the photograft polymerization method, the methods described in JP-A Nos. 63-92658, 10-296895 and 11-119413 may be used.

When a polymer layer of the invention is formed, in addition to the surface graft methods, a method of giving a reactive functional group such as a trialkoxysilyl group, an isocyanate group, an amino group, a hydroxyl group or a carboxyl group, to the terminal ends of a polymer compound chain, and binding this functional group to the functional group existing on the surface of the substrate by a coupling reaction, may also be applied.

Of these methods, it is preferable to form a polymer layer by photograft polymerization methods, particularly by photograft polymerization methods utilizing UV light, from the viewpoint of producing more graft polymers.

[Substrate]

The “substrate” of the invention is a substrate whose surface has a function of feasibly forming a state where a polymer having a functional group which is capable of interacting with a plating catalyst or a precursor thereof, is directly chemically bonded to the surface. The substrate itself may have such surface characteristics, or an intermediate layer (for example, a polymerization initiation layer that will be described later) may be separately formed on a base material, and the intermediate layer may have such characteristics.

(Base Material and Substrate)

The base material used in the invention is preferably a dimensionally stable plate-like object, and examples thereof include paper, paper laminated with plastics (for example, polyethylene, polypropylene, polystyrene and the like), metal plates (for example, aluminum, zinc, copper and the like), plastic films (for example, cellulose diacetate, cellulose triacetate, cellulose propionate, cellulose butyrate, cellulose acetate, nitrocellulose, polyethylene terephthalate, polyethylene, polystyrene, polypropylene, polycarbonates, polyvinylacetal, polyimides, epoxy resin, bismaleimide resins, polyphenylene oxide, liquid crystalline polymers, polytetrafluoroethylene and the like), paper or plastic films laminated or deposited with metals as described above, and the like. As the base material to be used in the invention, an epoxy resin or a polyimide resin is preferred.

In the case where the surface of such a base material has a function of feasibly forming a state where a polymer having a functional group capable of interacting with a plating catalyst or a precursor thereof is directly chemically bonded to the surface, the base material itself may be used as the substrate.

As the substrate according to the invention, the base material containing a polyimide which has a polymerization initiation site in the skeleton, as described in paragraphs (0028) to (0088) of JP-A No. 2005-281350, may also be used.

The metallic pattern-bearing material obtained by the process for producing a metallic pattern-bearing material of the invention may be applied to semiconductor packages, various electrical wiring boards, and the like. In the case of using the material in such applications, it is preferable to use a substrate containing an insulating resin, which will be shown below. Specifically, it is preferable to use a substrate formed from an insulating resin, or a substrate having a layer formed from an insulating resin, on a base material.

In the case of obtaining a substrate formed from an insulating resin or a layer formed from an insulating resin, a known insulating resin composition is used. In this insulating resin composition, various additives may be used in combination according to the intended use, in addition to the resin which is the main component. For example, measures may be taken, such as adding a polyfunctional acrylate monomer for the purpose of increasing the strength of the insulating layer, adding inorganic or organic particles for the purpose of increasing the strength of the insulating layer and improving electrical properties, and the like.

Here, the “insulating resin” according to the invention means a resin having insulating properties to the extent that the resin may be used in known insulating films or insulating layers, and even though the resin is not a perfect insulating body, as long as the resin has the insulating properties fitting to the intended use, the resin is applicable to the invention.

The insulating resin may be a thermosetting resin, a thermoplastic resin, or a mixture thereof. Specifically, examples of the thermosetting resin include epoxy resins, phenolic resins, polyimide resins, polyester resins, bismaleimide resins, polyolefin-based resins, isocyanate-based resins, and the like.

Examples of the epoxy resins include cresol novolac type epoxy resins, bisphenol A type epoxy resins, bisphenol F type epoxy resins, phenol novolac type epoxy resins, alkylphenol novolac type epoxy resins, biphenol F type epoxy resins, naphthalene type epoxy resins, dicyclopentadiene type epoxy resins, epoxides of condensates of a phenol and an aromatic aldehyde having a phenolic hydroxyl group, triglycidyl isocyanurate, alicyclic epoxy resins, and the like. These resins may be used alone, or may be used in combination of two or more kinds thereof, thereby, obtaining a product having excellent heat resistance and the like.

Examples of the polyolefin-based resins include polyethylene, polystyrene, polypropylene, polyisobutylene, polybutadiene, polyisoprene, cycloolefin-based resins, copolymers of these resins, and the like.

Examples of the thermoplastic resins include phenoxy resins, polyethersulfone, polysulfone, polyphenylenesulfone, polyphenylene sulfide, polyphenyl ether, polyetherimide, and the like.

Other thermoplastic resins include 1,2-bis(vinylphenylene)ethane resin, or a modified resin of the 1,2-bis(vinylphenylene)ethane resin and a polyphenylene ether resin (described in Satoru Amou, et al., Journal of Applied Polymer Science, Vol. 92, 1252-1258 (2004)), liquid crystalline polymers (specifically, VECSTAR (trade name) manufactured by Kuraray Co., Ltd., and the like), fluororesins (PTFE), and the like.

The thermoplastic resins and the thermosetting resins may be respectively used alone, or may also be used in combination of two or more kinds thereof. This is implemented for the purpose of making up for the shortcomings of the individual resins and manifesting more excellent effects. For example, since thermoplastic resins such as polyphenylene ether (PPE) have low resistance to heat, the thermoplastic resins are alloyed with thermosetting resins or the like. For example, products formed by alloying PPE with epoxy and triallyl isocyanate, or by alloying a PPE resin having a polymerizable functional group introduced thereinto, with another thermosetting resin, are used. Of the thermosetting resins, cyanate esters are resins having the most excellent dielectric properties, but the cyanate esters are seldom used alone, and are used as modified resins with epoxy resins, maleimide resins, thermoplastic resins or the like. Details of these are described in “Electronic Technology,” No. 2002/9, p., 35. Furthermore, a mixture containing an epoxy resin and/or a phenolic resin as the thermosetting resin, and containing a phenoxy resin and/or polyethersulfone (PES) as the thermoplastic resin, is also used to improve the dielectric properties.

The insulating resin composition may contain a compound such as a compound having a polymerizable double bond, specifically an acrylate or methacrylate compound, in order to facilitate crosslinking, and particularly, a polyfunctional compound is preferred. In addition, as the compound having a polymerizable double bond, a resin obtained in such a manner that a part of a thermosetting resin or a thermoplastic resin, for example, an epoxy resin, a phenolic resin, a polyimide resin, a polyolefin resin, a fluororesin or the like is subjected to a (meth)acrylation reaction using methacrylic acid, acrylic acid or the like, may also be used.

In the insulating resin composition, composites (composite materials) of a resin and another component may also be used to improve the properties such as mechanical strength, heat resistance, weather resistance, flame resistance, water resistance and electrical properties, of resin films. Examples of the material that may be used for producing composite materials include paper, glass fiber, silica particles, phenolic resins, polyimide resins, bismaleimide triazine resins, fluororesins, polyphenylene oxide resins, or the like.

Furthermore, this insulating resin composition may be compounded with, if necessary, one or two or more fillers that are used in general resin materials for wiring boards, examples of which include inorganic fillers such as silica, alumina, clay, talc, aluminum hydroxide or calcium carbonate, and organic fillers such as hardened epoxy resins, crosslinked benzoguanamine resins or crosslinked acrylic polymers. Of these fillers, it is preferable to use silica as the filling material.

To this insulating resin composition, may also be added one or two or more of various additives, including a colorant, a flame retardant, a tackifier, a silane coupling agent, an antioxidant, an ultraviolet absorber, and the like, as occasion demands.

When these materials are to be added to the insulating resin composition, it is preferable that all of the materials be added in an amount in the range of 1% by mass to 200% by mass, more preferably in the range of 10% by mass to 80% by mass, based on the resin. If this amount of addition is less than 1% by mass, the effects of improving the aforementioned properties are not obtained, while if the amount of addition is more than 200% by mass, the properties such as strength inherent to the resin are deteriorated.

It is preferable that the substrate to be used in such applications be specifically a substrate formed from an insulating resin having a dielectric constant (relative dielectric constant) of 3.5 or less at 1 GHz, or a substrate having a layer formed from the insulating resin on a base material. It is also preferable that the substrate be a substrate formed from an insulating resin having a dielectric loss tangent of 0.01 or less at 1 GHz, or a substrate having a layer formed from the insulating resin on a base material.

The dielectric constant and the dielectric loss tangent of an insulating resin may be measured by standard methods. For example, in accordance with the method recited in “Summary of 18th Lecture Meeting of Japan Institute of Electronics Packaging, p., 189 (2004), the properties can be measured by using a cavity resonator perturbation method (for example, Er for ultrathin sheet, tan δ measuring system, manufactured by Keycom Corp.).

Accordingly, in the invention, it is also useful to select an insulating resin material from the viewpoint of dielectric constant or dielectric loss tangent. As an insulating resin having a dielectric constant of 3.5 or less and a dielectric loss tangent of 0.01 or less, liquid crystalline polymers, polyimide resins, fluororesins, polyphenylene ether resins, cyanate ester resins, bis(bisphenylene)ethane resins, and the like may be exemplified, and the modified resins of these resins are also included.

The substrate to be used in the invention preferably has a surface roughness of 500 nm or less, more preferably 100 nm or less, even more preferably 50 nm or less, and most preferably 20 nm or less, in view of the applications in semiconductor packages, various electrical wiring boards and the like. As the surface roughness of the substrate (in the case where an intermediate layer or a polymerization initiation layer is provided, the surface roughness of that layer) is smaller, the electric loss at the time of high frequency transmission becomes smaller when the resulting metallic pattern-bearing material is applied to wiring or the like. This fact is preferable.

In the invention, when the substrate is a plate-shaped object, for example, a resin film (plastic film), the both surfaces of the substrate are subjected to the process (a1), thereby forming polymer layers on both surfaces of the resin film.

When the polymer layers have been formed on both surfaces of the resin film (substrate) in this way, the process (a2) and process (a3), that will be described later may be further carried out, thereby obtaining a metal film-coated material having metal films on the both surfaces of the resin film.

In the invention, when a surface graft polymerization method, in which an active species is generated on the substrate surface, and a graft polymer is produced from the active species as a starting point, is used, at the time of the production of a graft polymer, it is preferable to use a substrate having a polymerization initiation layer which contains a polymerization initiator or has a functional group capable of initiating polymerization, formed on a base material. By using this substrate, active sites can be efficiently generated, and thus more graft polymer chains can be produced.

Hereinafter, the polymerization initiator layer according to the invention will be discussed. Here, if the base material is a plate-shaped object, the polymerization layer may be formed on both surfaces thereof.

(Polymerization Initiation Layer)

As the polymerization initiation layer in the invention, a layer containing a polymer compound and a polymerization initiator; a layer containing a polymerizable compound and a polymerization initiator; and a layer having a functional group capable of initiating polymerization may be exemplified.

The polymerization initiation layer according to the invention may be formed in such a manner that necessary components are dissolved in a solvent capable of dissolving the components, a film is formed from the resultant solution on the surface of a base material by using methods such as coating, and the film is cured by heating or photoirradiation.

As for the compound to be used in the polymerization initiation layer according to the invention, any compound may be used without particular limitation, as long as a compound has good adhesion to the base material, and generates active species by applying energy such as actinic ray irradiation to the compound. Specifically, a mixture of a hydrophobic polymer having a polyfunctional monomer or a polymerizable group in the molecule and a polymerization initiator, or a mixture of a thermal crosslinkable polymer and a polymerization initiator may be used.

As to details of various compounds used for forming the polymerization initiation layer, and matters relating to the methods of forming the polymerization initiation layer, contents in paragraphs (0042] to (0048) of JP-A No. 2007-154306, are also applicable to the polymerization initiation layer in the invention. In addition, of the compounds usable in the polymerization initiation layer, an epoxy resin, a phenol resin, a melamine resin, a urea resin, a thermosetting polyimide resin or the like can be used as the thermal crosslinkable polymer.

In addition to the polymerizable compound and the polymerization initiation layer having a polymerization initiator, a polymerization initiation layer using a polymer having a polymerization initiating group in the side chain of the polymer as a pendant group as recited in JP-A No. 2004-161995 is also preferred. As to details of various compounds used in such a polymerization initiation layer, and matters relating to the methods of forming the polymerization initiation layer, matters recited in paragraphs (0049] to (0061) of JP-A No. 2007-154306, are also applicable to the invention.

Further, in the invention, when a substrate having a layer formed from an insulating resin as described above on a base material is used, it is preferable that a known polymerization initiator be contained in this layer formed from the insulating resin to form an insulative polymerization initiation layer. The polymerization initiator to be contained in this insulative polymerization initiation layer is not particularly limited, and for example, the above thermal polymerization initiators, photopolymerization initiators (radical polymerization initiators, anionic polymerization initiators, and cationic polymerization initiators), or the polymer compounds having an active carbonyl group in the side chain as described in JP-A Nos. 9-77891 and 10-45927, a polymer (polymerization initiating polymer) having a crosslinkable group and a functional group with polymerization initiation capability in the side chain, and the like may be used.

The amount of the polymerization initiator to be contained in the insulative polymerization initiation layer is generally preferably about 0.1% by mass to 50% by mass, and more preferably about 1.0% by mass to 30.0% by mass, based on the solid components in the insulating layer.

(Production of Graft Polymer)

In an exemplary embodiment of the production of a graft polymer in the process (a1), as described above, a method of utilizing the coupling reaction between the functional group existing on the surface of the substrate and the reactive functional group carried by the polymer compound at the chain ends or in the side chain, or a photograft polymerization method may be used.

In the invention, an exemplary embodiment [process (a1-2)], in which a substrate having a polymerization initiation layer formed on a base material is used, and a polymer layer formed from a polymer which has a functional group (interactive group) capable of interacting with a plating catalyst or a precursor thereof, and which is directly chemically bonded to the polymerization initiation layer, is formed on the polymerization initiation layer, is preferred. In a more preferred exemplary embodiment, after a polymer having a polymerizable group and an interactive group is contacted with the surface of the polymerization initiation layer, energy is applied to the polymer, so that the polymer is directly chemically bonded to the entire surface of the substrate (entire surface of the polymerization initiation layer). That is, while bringing a composition containing a compound having a polymerizable group and an interactive group into contact with the surface of the polymerization initiation layer, the composition is directly bonded to the surface of the polymerization initiation layer with the use of the active species generated at the surface of the polymerization initiation layer.

The contact in the above may be carried out by immersing a substrate having a polymerization initiation layer formed thereon, into a liquid composition containing a compound of the invention, but from the viewpoint of handling property or production efficiency, as will be described later, it is preferable that a layer formed from the composition of the invention be formed on the surface (surface of the polymerization initiation layer) of the substrate by a coating method.

In order to form the polymer layer of the invention, the composition containing the cyano group-containing polymerizable polymer of the invention is used.

Details of the cyano group-containing polymerizable polymer of the invention and the composition using the polymer are described in the above.

When the composition of the invention is brought into contact with the substrate, the coating amount of the composition is preferably 0.1 g/m² to 10 g/m², and particularly preferably 0.5 g/m² to 5 g/m², based on the solid content, from the viewpoint of sufficient interaction formability with the plating catalyst or the precursor thereof.

When a polymer layer is formed in the process (a1), the coated substrate may be allowed to stand for 0.5 to 2 hours at temperatures of 20° C. to 40° C., between the coating process and the drying process to remove remaining solvent.

(Application of Energy)

As the method of applying energy to the substrate surface, for example, a method of utilizing irradiation with radiant rays such as heating or light exposure may be exemplified. Examples of the method include photoirradiation by using a UV lamp or visible light, heating by using a hot plate, and the like. The light sources that may be used for the methods include, for example, a mercury lamp, a metal halide lamp, a xenon lamp, a chemical lamp, a carbon arc lamp, and the like. Examples of the radiant rays include electron beam, X-rays, ion beam, far-infrared rays, and the like. Furthermore, g-ray, i-ray, deep-UV light, and high density energy beam (laser beam) may also be used.

Of generally used methods, examples of exemplary embodiments include direct image-wise recording with a thermal recording head or the like, scanning exposure to infrared laser, high illuminance flash exposure to a xenon discharge lamp or the like, exposure to an infrared lamp, and the like.

The time required for applying energy may vary with the amount of production of the desired graft polymer and the light source, but the time is usually between 10 seconds and 5 hours.

When energy is applied by exposure to light, the exposure power is preferably in the range of 10 mJ/cm² to 5,000 mJ/cm², and more preferably in the range of 50 mJ/cm² to 3,000 mJ/cm², in order to facilitate graft polymerization, and to suppressing the decomposition of the produced graft polymer.

Further, when a polymer having an average molecular weight of 20,000 or more and a polymerization degree of 200-mers or more is used as the compound having a polymerizable group and an interactive group, the graft polymerization process proceeds easily by exposure to low energy radiation, and thus, the decomposition of the produced graft polymer may be further suppressed.

In the process (a1) described above, a polymer layer formed from a graft polymer having an interactive group (graft polymer layer) can be formed on the substrate.

If the decomposition of the polymerizable moieties of the obtained polymer layer takes place to an extent of 50% or less, for example, when the polymer layer is immersed in an alkaline solution at pH 12 and the solution is stirred for 1 hour, the polymer layer may be subjected to washing with a highly alkaline solution.

Process (a2)

In the process (a2), a plating catalyst or a precursor thereof is applied to the polymer layer formed in the process (a1). In this process, the cyano group (interactive group) carried by the graft polymer constituting the polymer layer adheres (adsorbs) to the applied plating catalyst or a precursor thereof, according to the function of the group.

Here, the plating catalyst or a precursor thereof which functions as a catalyst for plating or as an electrode in the plating process (a3), that will be described later, is exemplified. For that reason, the plating catalyst or a precursor thereof is determined on the basis of the type of plating in the plating process (a3).

Additionally, the plating catalyst or a precursor thereof used in this process is preferably an electroless plating catalyst or a precursor thereof.

(Electroless Plating Catalyst)

The electroless plating catalyst used in the invention may be any compound as long as it serves as an active nucleus in the course of electroless plating. Specifically, examples thereof include metals having catalytic capability for the self-catalytic reduction reaction (those known as metals capable of performing electroless plating with a low ionization tendency than that of Ni), and the like. Specifically, examples of the metals include Pd, Ag, Cu, Ni, Al, Fe, Co and the like. Of these metals, metals which can form multidentate coordination are preferred. In particular, from the viewpoint of the number of types of the functional groups which can form coordination and the superiority of the catalytic capability, Pd is particularly preferred.

This electroless plating catalyst may be used in the form of a metal colloid. In general, a metal colloid may be produced by reducing metal ions in a solution containing a surfactant carrying an electrical charge or a protective agent carrying an electrical charge. The electrical charge of the metal colloid may be controlled by the surfactant or protective agent used herein.

(Electroless Plating Catalyst Precursor)

As the electroless plating catalyst precursor used in this process, any compound may be used without particular limitation as long as it may become an electroless plating catalyst by a chemical reaction. In most cases, metal ions of those metals exemplified as the electroless plating catalysts are used. A metal ion which is an electroless plating catalyst precursor becomes zero-valent metal which is an electroless plating catalyst, through a reduction reaction. The metal ion which is an electroless plating catalyst precursor may be converted to zero-valent metal through a separate reduction reaction after being applied to the polymer layer and before being immersed into an electroless plating bath, to obtain an electroless plating catalyst, or may be immersed in an electroless plating bath while still being an electroless plating catalyst precursor to be converted to metal (electroless plating catalyst) by the action of a reducing agent in the electroless plating bath.

In practice, the metal ion as the electroless plating precursor is applied onto the polymer layer by using a metal salt. The metal salt to be used is not particularly limited as long as it may be dissolved in an appropriate solvent to be dissociated into a metal ion and a base (anion). Specifically, examples thereof include M(NO₃)ₙ, MClₙ, M_{2/n}(SO₄), M_{3/n}(PO₄)Pd(OAc)ₙ (wherein M represents an n-valent metal atom) and the like. As the metal ions, the ions resulting from the dissociation of the above metal salts may be suitably used. Specifically, examples thereof include, for example, Ag ion, Cu ion, Al ion, Ni ion, Co ion, Fe ion and Pd ion. Of these ions, ions which can form multidentate coordination are preferred. In particular, from the viewpoint of the number of kinds of the functional group which can be coordinated and the catalytic capability, Pd ion is preferred.

As the method of applying a metal as an electroless plating catalyst or a metal salt as an electroless plating precursor to the polymer layer, a dispersion formed by dispersing a metal in an appropriate dispersion medium, or a solution containing dissociated metal ions resulting from dissolution of a metal salt in an appropriate solvent may be prepared, and the dispersion or the solution may be applied onto the polymer layer, or a substrate having a polymer layer formed thereon may be immersed in the dispersion or the solution.

When the surface graft polymerization method is used in the process (a1), a composition containing a compound containing the cyano group-containing polymerizable polymer of the invention is brought into contact with the surface of the substrate, and a method of adding an electroless plating catalyst or a precursor thereof into this composition may be used. A composition containing the cyano group-containing polymerizable polymer of the invention and an electroless plating catalyst or a precursor thereof is brought into contact with the surface of the substrate, and the surface graft polymerization method is applied thereto, so that a polymer layer containing a polymer which has a cyano group (interactive group) and is directly chemically bonded to the substrate, and a plating catalyst or a precursor thereof, may be formed. Further, if this method is used, the process (a1) and the process (a2) according to the invention may be carried out in one process.

When the electroless plating catalyst or a precursor thereof is contacted as described above, the electroless plating catalyst or a precursor thereof may be adsorbed to the cyano group (interactive group) in the polymer layer, by using the interaction based on intermolecular force such as van der Waals force, or the interaction based on the coordinate bond by a lone pair of electrons.

In the viewpoint of sufficiently achieving such adsorption, the metal concentration in the dispersion, solution or composition, or the metal ion concentration in the solution is preferably in the range of 0.001% by mass to 50% by mass, and more preferably in the range of 0.005% by mass to 30% by mass. The contacting time is preferably about 30 seconds to 24 hours, and more preferably about 1 minute to 1 hour.

As solvents which may be used in a solution containing the electroless plating catalyst, the solvent used in the composition of the invention as described above may also be used.

(Other Catalysts)

In the process (a3), that will be described later, in the invention, as the catalyst used to directly perform electroplating to the polymer layer without performing electroless plating, a zero-valent metal may be used. Examples of the zero-valent metal include Pd, Ag, Cu, Ni, Al, Fe, Co and the like. Of these metals, metals which can form multidentate coordination are preferred. In particular, from the viewpoints of the adsorptivity (adherence) to the interactive group (cyano group) and the superiority of the catalytic capability, Pd, Ag and Cu are preferred.

By way of the process (a2) as described above, the interaction between the interactive group (cyano group) in the polymer layer and the plating catalyst or a precursor thereof may be formed.

[Process (a3)]

In the process (a3), a plating film is formed by performing plating on the polymer layer to which an electroless plating catalyst or a precursor thereof has been applied. The formed plating film has excellent electroconductivity and adhesiveness.

As the type of plating performed in this process, the electroless plating, electroplating or the like may be exemplified, and in the process (a2), the plating may be selected based on the function of the plating catalyst or a precursor thereof which has interacted with the polymer layer.

That is, in this process, electroplating may be performed or electroless plating may be performed on the polymer layer to which a plating catalyst or a precursor thereof has been applied.

Of these, in the invention, it is preferable to perform electroless plating, from the viewpoint of the formability of a hybrid structure generated in the polymer layer and the enhancement of adhesiveness. Furthermore, in order to obtain a plating layer with a desired thickness, in a more preferred exemplary embodiment, electroplating is performed after electroless plating.

Hereinafter, the plating that is suitably carried out in this process will be described.

(Electroless Plating)

Electroless plating means an operation of precipitating metal by a chemical reaction, by using a solution in which the metal ions to be precipitated out as plating are dissolved.

The electroless plating in this process is carried out, for example, by washing the substrate to which an electroless plating catalyst has been applied, with water to remove any excess electroless plating catalyst (metal), and then immersing the substrate in an electroless plating bath. As the electroless plating bath to be used, those generally known electroless plating baths may be used.

When a substrate having an electroless plating catalyst precursor provided thereon is immersed in the electroless plating bath in a state where the electroless plating catalyst precursor is adsorbed or impregnated in the polymer layer, this substrate is immersed into the electroless plating bath after the substrate is washed with water to remove excess precursor (metal salt or the like). In this case, the plating catalyst precursor is reduced, followed by electroless plating in the electroless plating bath. For the electroless plating bath to be used herein, those generally known electroless plating baths may be also used, likewise as described above.

Further, the reduction of the electroless plating catalyst precursor may also be carried out in a separate process prior to the electroless plating, by preparing a catalyst activating liquid (reducing liquid) separately from the exemplary embodiment of using an electroless plating liquid as described above. The catalyst activating liquid is a liquid in which a reducing agent capable of reducing an electroless plating catalyst precursor (mainly a metal ion) to zero-valent metal, is dissolved, and the concentration of the precursor is in the range of 0.1% to 50%, and is preferably in the range of 1% to 30%. As the reducing agent, boron-based reducing agents such as sodium borohydride and dimethylamine borane, and reducing agents such as formaldehyde and hypophosphorous acid may be used.

The composition of an electroless plating bath which is generally used mainly includes, in addition to the solvent, (1) metal ions for plating, (2) a reducing agent, and (3) additives (stabilizer) for enhancing the stability of the metal ions. The plating bath may also contain, in addition to these, known additives such as a stabilizer for the plating bath.

The solvent used in this plating bath contains preferably an organic solvent which has high affinity for the polymer layer with low water absorptivity and high hydrophobicity. The type of the organic solvent may be selected, or the content may be adjusted in accordance with the physical properties of the polymer layer. Particularly, with an increase in saturated water absorptivity in the polymer layer, it is preferable that the content of the organic solvent be smaller. Specifically, details are as follows.

That is, if the saturated water absorptivity in the polymer layer is 0.01% by mass to 0.5% by mass, the content of the organic solvent in the total solvents in the plating bath is preferably 20% by mass to 80% by mass, and if the saturated water absorptivity is 0.5% by mass to 5% by mass, the content of the organic solvent in the total solvents in the plating bath is preferably 10% by mass to 80% by mass. If the saturated water absorptivity is 5% by mass to 10% by mass, the content of the organic solvent in the total solvents in the plating bath is preferably 0 to 60% by mass, and if the saturated water absorptivity is 10% by mass to 20% by mass, the content of the organic solvent in the total solvents in the plating bath is preferably 0 to 45% by mass.

The organic solvent used in the plating bath needs to be a solvent miscible with water, and from this point of view, ketones such as acetone, and alcohols such as methanol, ethanol and isopropanol are preferably used.

As the type of metal used in the electroless plating bath, copper, tin, lead, nickel, gold, palladium and rhodium are known, and of these metals, from the viewpoint of electrical conductivity, copper and gold are particularly preferred.

Further, there are reducing agents and additives that are optimal metals in accordance with the metals. For example, the electroless plating bath for copper contains CuSO₄ as a copper salt, HCOH as a reducing agent, and as additives such as EDTA or Rochelle salt which is a chelating agent as a stabilizer of copper ions, or trialkanolamine and the like. The plating bath used for electroless plating of CoNiP contains cobalt sulfate and nickel sulfate as metal salts, sodium hypophosphite as a reducing agent, and sodium malonate, sodium malate or sodium succinate as a complexing agent. The electroless plating bath for palladium contains (Pd(NH₃)₄)Cl₂ as a metal ion, NH₃ or H₂NNH₂ as a reducing agent, and EDTA as a stabilizer. These plating baths may also include components other than the above components.

The film thickness of the plating film thus formed by electroless plating may be controlled by the metal ion concentration of the plating bath, the immersion time in the plating bath, the temperature of the plating bath, or the like. From the viewpoint of electrical conductivity, the film thickness is preferably 0.5 μm or more, and more preferably 3 μm or more.

The immersion time in the plating bath is preferably about 1 minute to 6 hours, and more preferably about 1 minute to 3 hours.

It was confirmed that in the plating film thus obtained by electroless plating, microparticles formed from the electroless plating catalyst or plating metal are densely dispersed in the polymer layer, and further, the plating metal is precipitated out on the polymer layer, from the observation of the cross-section of the plating film with a scanning electron microscope (SEM). Since the interface between the substrate and the plating film is in a state where a hybrid of the polymer and the microparticles is formed, even if the interface between the substrate (organic component) and the inorganic substance (catalyst metal or plating metal) is flat and smooth (for example, the roughness difference is 500 nm or less), the adhesiveness becomes good.

(Electroplating)

In this process, if the plating catalyst or a precursor thereof provided during the process (a2) functions as an electrode, electroplating may be performed on the polymer layer to which the catalyst or a precursor thereof has been applied.

Further, the electroplating may also be carried out after the electroless plating, by using the formed plating film as an electrode. Thus, the electroless plating film having excellent adhesiveness to the substrate is used as a base, and a metal film having an arbitrary thickness may be additionally and easily formed thereon. In this way, by performing electroplating after electroless plating, a metal film may be formed to have a thickness in accordance with the intended use, and thus the metal film of the invention is suitable to be applied to various applications.

As the method for electroplating according to the invention, conventionally known methods may be used. In addition, examples of the metal used in the electroplating of the process include copper, chromium, lead, nickel, gold, silver, tin, zinc and the like. From the viewpoint of electrical conductivity, copper, gold and silver are preferred, and copper is more preferred.

The thickness of the metal film obtained by electroplating may vary with the use, and may be controlled by adjusting the metal concentration contained in the plating bath, current density or the like. In addition, from the viewpoint of electrical conductivity, the film thickness in the case of being used in general electrical wiring or the like is preferably 0.5 μm or more, and more preferably 3 μm or more.

In the invention, the metal or metal salt resulting from the plating catalyst or a plating catalyst precursor, and/or the metal precipitated in the polymer layer by electroless plating forms a fractal-like microstructure in the layer, thereby further enhancing the adhesiveness between the metal film and the polymer layer.

As the amount of metal existing in the polymer layer, when the cross-sectional profile of the substrate is photographed with a metal microscope, the proportion of metal contained in a region extending from the outermost surface of the polymer layer down to a depth of 0.5 μm is 5% by area to 50% by area, and when the arithmetic average roughness Ra (JIS B0633-2001) of interface between the polymer layer and the metal interface is 0.05 μm to 0.5 μm, even stronger adhesive force is manifested.

[Metal Film-Coated Material]

By way of the respective processes of the process for producing a metal film-coated material of the invention, the metal film-coated material of the invention can be obtained.

The metal film-coated material obtained by the process for producing a metal film-coated material of the invention has an effect such that the adhesive force of the metal film is less fluctuated even under high temperature and high humidity. This metal film-coated material may be applied to various applications such as, for example, electromagnetic wave shielding films, coating films, two-layer CCL (copper clad laminate) materials, and materials for electrical wiring.

The process for producing a metallic pattern-bearing material of the invention includes a process of pattern-wise etching the plating film of the metal film-coated material of the invention obtained through the processes of (a1) to (a3).

Hereinafter, the etching process (a4) will be described.

[Process (a4)]

In the process (a4), the plating film (metal film) formed in the process (a3) is pattern-wise etched. That is, in this process, a desired metallic pattern may be formed by removing unnecessary portions of the plating film formed over the entire surface of the substrate, by etching.

In the formation of this metallic pattern, any technique may be used, and specifically, the generally known subtractive method and semi-additive method are used.

The subtractive method is a method of forming a metallic pattern by providing a dry film resist layer on the formed plating film, forming the same pattern as the metallic pattern part through pattern-wise exposure and development, and removing the plating film with an etching solution while using the dry film resist pattern as the mask. As the dry film resist, any material may be used, and a negative type, a positive type, a liquid-like or a film-like material may be used. As the etching method, any of the methods that are being used in the production of printed-wiring boards may be used, and wet etching, dry etching or the like may be used. Thus, any method may be arbitrarily selected. From the viewpoint of process operation, wet etching is preferred because the apparatuses and the like are convenient. As an example of the etching solution that may be used, an aqueous solution of cupric chloride, ferric chloride or the like may be exemplified.

The semi-additive method is a method of forming a metallic pattern by providing a dry film resist layer on the formed plating film, forming the same pattern as the non-metallic pattern part through pattern-wise exposure and development, performing electroplating while using the dry film resist pattern as the mask, performing quick etching after removing the dry film resist pattern, and pattern-wise removing the plating film. As the materials for the dry film resist, etching solution and the like, the same materials as those in the subtractive method may be used. Further, as for the electroplating technique, the described techniques described above may be used.

By way of the processes (a1) to (a4) described above, a metallic pattern-bearing material having a desired metallic pattern is produced.

Meanwhile, a metallic pattern-bearing material may also be produced by forming the polymer layer obtained by the process (a1) in a pattern-wise manner, and performing the processes (a2) and (a3) on the pattern-bearing polymer layer (full additive technique).

As the method of forming the polymer layer obtained by the process (a1) in a pattern-wise manner, specifically, the energy applied when forming the polymer layer may be applied pattern-wisely, and when the portion where energy is not applied is removed by development, a pattern-bearing polymer layer may be formed.

Moreover, the development is carried out by immersing a material such as the compound having a polymerizable group and an interactive group (cyano group) used for forming a polymer layer in a solvent capable of dissolving the material. The time for the immersion is preferably in the range of 1 minute to 30 minutes.

The polymer layer formed in the process (a1) may also be formed by directly patterning the polymer layer by a known coating method such as a gravure printing method, an inkjet method, or a spray coating method using a mask, followed by applying energy thereto, and then developing the pattern.

The processes (a2) and (a3) for forming a plating film on the polymer layer with a pattern formed thereon, are the same as the processes described above.

[Metallic Pattern-Bearing Material]

The metallic pattern-bearing material of the invention is a product obtained by the process for producing a metallic pattern-bearing material of the invention.

Since the polymer layer for forming the obtained metallic pattern-bearing material has low water absorptivity and high hydrophobicity as described above, the exposed portions (area where no metallic pattern is formed) of this polymer layer have excellent insulation reliability.

The metallic pattern-bearing material of the invention is preferably provided with a metal film (plating film) on the entire surface or a local surface of the substrate having a roughness of 500 nm or less (more preferably, 100 nm or less). Further, it is also preferable that the adhesiveness between the substrate and the metallic pattern be 0.2 kN/m or more. That is, the substrate surface has excellent adhesiveness between the substrate and the metallic pattern, while the substrate has a flat and smooth surface.

Here, the roughness of the surface of the substrate is a value measured by cutting the substrate perpendicularly to the substrate surface, and observing the cross-sectional profile with an SEM.

More particularly, it is preferable that Rz of the surface of the substrate measured according to JIS B 601, that is, the “difference between the average value of the Z data from the maximum peak height to the fifth peak height, and the average value from the minimum valley depth to the fifth valley depth in a designated profile” be 500 nm or less.

The value of adhesiveness between the substrate and the metal film is a value obtained by adhering a copper plate (thickness: 0.1 mm) on the surface of the metal film (metallic pattern) with an epoxy-based adhesive (trade name: ARALDITE; manufactured by Ciba Geigy, Ltd.), drying the assembly for 4 hours at 140° C., and then performing the 90-degree exfoliation test based on JIS C 6481, or directly peeling off the edge parts of the metal film itself, and performing the 90-degree exfoliation test based on JIS C 6481.

The metallic pattern-bearing material obtained by the process for producing a metallic pattern-bearing material of the invention may be applied to various applications such as semiconductor chips, various electrical wiring boards, FPC, COF, TAB, antennas, multilayer wiring boards, and motherboards.

According to the invention, a novel copolymerization polymer which has sufficient adsorptivity to metal such as a plating catalyst, low water absorptivity, and excellent polymerizability, and which can suppress hydrolysis caused by an aqueous alkali solution and hydrolysis under high-pressure, high humidity and high temperature conditions, and a composition and a laminate body respectively containing the polymer, can be provided.

Further, according to the invention, by using the composition containing the novel copolymerization polymer of the invention, a metal film-coated material having excellent adhesiveness between a metal film and a substrate, and a method of producing the same, can be provided.

Moreover, according to the invention, by using a metal film-coated material of the invention, a metallic pattern-bearing material which has excellent insulation reliability in a region where a metallic pattern is not formed, and a method of producing the same, can be provided.

### EXAMPLES

Hereinafter, the invention will be described in detail by way of Examples, but the invention is not intended to be limited to these. Particularly, unless otherwise specified, the terms “%” and “part” are on the mass basis.

### Example 1

### Synthetic Example: Synthesis of Cyano Group-Containing Polymerizable Polymer A

In a 300 ml three-necked flask, were placed 73 g of tertiary butylamine (commercial product; manufactured by Sigma-Aldrich Corporation) and 7.3 g of water, and heated to 45° C. To this, was added dropwise 53 g of acrylonitrile (commercial product; manufactured by Wako Pure Chemical Industries, Ltd.). After finishing the dropwise addition, the mixture was reacted for three hours, and thereafter, was distilled under reduced pressure and 81 g of N-tertiary-butyl cyanoethylamine was obtained.

Next, 80 g of N-tertiary-butyl cyanoethylamine and 500 g of ethylacetate were placed in a 1000 ml of three-necked flask, and the mixture was cooled to 5° C. To this, was added dropwise 43 g of acryloyl chloride (commercial product; manufactured by Tokyo Chemical Industry Co., Ltd.). After completion of the dropwise addition, the temperature of the reaction liquid was returned to room temperature and the reaction was performed for three hours. Thereafter, the reaction product was extracted with ethyl acetate, and washed with aqueous sodium hydrogencarbonate solution and salted water, and thereafter, the extract was dried with magnesium sulfate over night. A crude product obtained by evaporation was recrystallized with isopropyl alcohol, and 44 g of N-tertiary butyl cyanoethyl acrylamide was obtained.

Next, 22 g of dimethyl carbonate was placed in a 300 ml three-necked flask, and was heated to 65° C. in a stream of nitrogen. To this, 3.72 g of 2-hydroxyethyl acrylate (commercial product; manufactured by Tokyo Chemical Industry Co., Ltd.), 25.63 g of N-tertiary butyl cyanoethyl acrylamide, and 22 g of dimethyl carbonate solution containing 0.397 g of V-65 (trade name; manufactured by Wako Pure Chemical Industries, Ltd.) were added dropwise over 4 hours. After completion of the dropwise addition, the mixture was stirred for 3 hours. Thereafter the reaction solution was cooled to room temperature.

To this reaction solution, were added 0.093 g of TEMPO (trade name; manufactured by Tokyo Chemical Industry Co., Ltd.), 0.277 g of U-600 (trade name; manufactured by Nitto Kasei Kogyo K. K.), 8.4 g of KARENZ AOI (trade name; manufactured by Showa Denko K.K.), and 8.4 g of dimethyl carbonate, and the reaction solution was reacted at 45° C. for 6 hours. Thereafter, 1.1 g of water was added to the reaction solution, and the mixture was reacted for 1.5 hours. After completion of the reaction, reprecipitation was conducted with a mixed solution of ethyl acetate and hexane (1/3), and a solid product was collected to obtain 10 g of cyano group-containing polymerizable polymer A of the invention.

The structure of the cyano group-containing polymerizable polymer A in a state where the polymer was dissolved in d-DMSO and the solution was heated at 50° C. was identified by ¹H-NMR by using an NMR (manufactured by Bruker Corporation (400 MHz)). The polymer was dissolved in NMP, and the molecular weight of the polymer was measured by using a high performance GPC (trade name: HLC-8220GPC; manufactured by Tosoh Corporation). In addition, the molecular weight was calculated by polystyrene conversion. The weight average molecular weight of cyano group-containing polymerizable polymer A was 23,000. Cyano group-containing polymerizable polymer A has the following units.

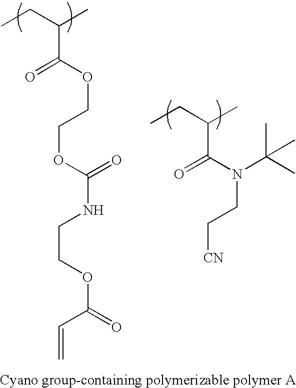

### Example 2

### Synthetic Example: Synthesis of Cyano Group-Containing Polymerizable Polymer B

In a 1000 ml three-necked flask, were placed 90 g of N-cyanoethyl aniline and 500 g of ethyl acetate, and the mixture was cooled to 5° C. To this, was added dropwise 42 g of acryloyl chloride (commercial product; manufactured by Tokyo Chemical Industry Co., Ltd.). After completion of the dropwise addition, the temperature of the reaction liquid was returned to room temperature and the reaction was performed for three hours. Thereafter, the reaction product was extracted with ethyl acetate, and washed with aqueous sodium hydrogencarbonate solution and salted water, and thereafter, was dried with magnesium sulfate over night. A crude product obtained by evaporation was purified by column chromatography, and 50 g of N-phenyl cyanoethyl acrylamide was obtained.

Next, 22 g of dimethyl carbonate was placed in a 300 ml three-necked flask, and was heated to 65° C. in a stream of nitrogen. To this, 3.72 g of 2-hydroxyethyl acrylate (commercial product; manufactured by Tokyo Chemical Industry Co., Ltd.), 25.6 g of N-phenyl cyanoethyl acrylamide, and 22 g of dimethyl carbonate solution containing 0.397 g of V-65 (trade name; manufactured by Wako Pure Chemical Industries, Ltd.) were added dropwise over 4 hours. After completion of the dropwise addition, the mixture was stirred for 3 hours. Thereafter, the reaction solution was cooled to room temperature.

To this reaction solution, were added 0.097 g of TEMPO (trade name; manufactured by Tokyo Chemical Industry Co., Ltd.), 0.29 g of U-600 (trade name; manufactured by Nitto Kasei Kogyo K. K.), 8.8 g of KARENZ AOI (trade name; manufactured by Showa Denko K.K.), and 8.8 g of dimethyl carbonate, and the reaction solution was reacted at 45° C. for 6 hours. Thereafter, 1.1 g of water was added to the reaction solution, and the mixture was reacted for 1.5 hours. After completion of the reaction, reprecipitation was conducted with a mixed solution of ethyl acetate and hexane (3/1), and a solid product was collected to obtain 12 g of cyano group-containing polymerizable polymer B of the invention.

The structure of the cyano group-containing polymerizable polymer B in a state where the polymer was dissolved in d-DMSO and the solution was heated at 50° C. was identified by ¹H-NMR by using an NMR (manufactured by Bruker Corporation (400 MHz)). The polymer was dissolved in NMP, and the molecular weight of the polymer was measured by using a high performance GPC (trade name: HLC-8220GPC; manufactured by Tosoh Corporation). In addition, the molecular weight was calculated by polystyrene conversion. The weight average molecular weight of cyano group-containing polymerizable polymer B was 39,000. Cyano group-containing polymerizable polymer B has the following units.

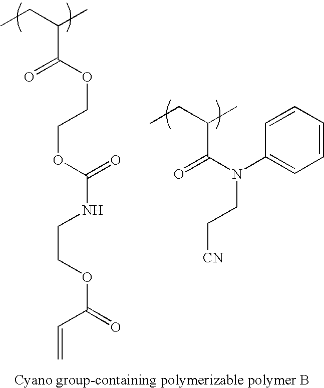

### Example 3

### Synthetic Example: Synthesis of Cyano Group-Containing Polymerizable Polymer C

In a 1000 ml three-necked flask, were placed 30 g of N-methyl cyanoethylamine and 500 g of ethyl acetate, and the mixture was cooled to 5° C. To this, was added dropwise 42 g of acryloyl chloride (commercial product; manufactured by Tokyo Chemical Industry Co., Ltd.). After completion of the dropwise addition, the temperature of the reaction liquid was returned to room temperature and the reaction was performed for three hours. Thereafter, the reaction product was extracted with ethyl acetate, and the extract was washed with aqueous sodium hydrogencarbonate solution and salted water, and thereafter, was dried with magnesium sulfate over night. A crude product obtained by evaporation was purified by column chromatography, and 15 g of N-methyl cyanoethyl acrylamide was obtained.

Next, 22 g of dimethyl carbonate was placed in a 300 ml three-necked flask, and was heated to 65° C. in a stream of nitrogen. To this, 3.72 g of 2-hydroxyethyl acrylate (commercial product; manufactured by Tokyo Chemical Industry Co., Ltd.), 8.2 g of N-methyl cyanoethyl acrylamide, and 22 g of dimethyl carbonate solution containing 0.397 g of V-65 (trade name; manufactured by Wako Pure Chemical Industries, Ltd.) were added dropwise over 4 hours. After completion of the dropwise addition, the mixture was stirred for 3 hours. Thereafter, the reaction solution was cooled to room temperature.

To this reaction solution, were added 0.097 g of TEMPO (trade name; manufactured by Tokyo Chemical Industry Co., Ltd.), 0.29 g of U-600 (trade name; manufactured by Nitto Kasei Kogyo K. K.), 8.8 g of KARENZ AOI (trade name; manufactured by Showa Denko K.K.), and 8.8 g of dimethyl carbonate, and the reaction solution was reacted at 45° C. for 6 hours. Thereafter, 1.1 g of water was added to the reaction solution, and the mixture was further reacted for 1.5 hours. After completion of the reaction, reprecipitation was conducted with a mixed solution of ethyl acetate and hexane (3/1), and a solid product was collected to obtain 8 g of cyano group-containing polymerizable polymer C of the invention.

The structure of the cyano group-containing polymerizable polymer C in a state where the polymer was dissolved in d-DMSO and the solution was heated at 50° C. was identified by ¹H-NMR by using an NMR (manufactured by Bruker Corporation (400 MHz)). The polymer was dissolved in NMP, and the molecular weight of the polymer was measured by using a high performance GPC (trade name: HLC-8220GPC; manufactured by Tosoh Corporation). In addition, the molecular weight was calculated by polystyrene conversion. The weight average molecular weight of cyano group-containing polymerizable polymer C was 25,000. Cyano group-containing polymerizable polymer C has the following units.

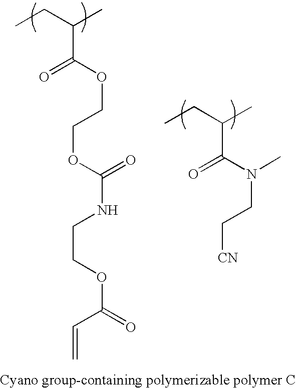

### Example 4

### Synthetic Example: Synthesis of Cyano Group-Containing Polymerizable Polymer D

In a 1000 ml three-necked flask, were introduced 247 g of tertiary butylamine (commercial product; manufactured by Sigma-Aldrich Corporation) and 100 g of 4-bromobutylnitrile (commercial product; manufactured by Wako Pure Chemical Industries, Ltd.), and 10.1 g of sodium iodide (commercial product; manufactured by Wako Pure Chemical Industries, Ltd., and the mixture was heated to 45° C. and was reacted for 8 hours, followed by reacting at room temperature for 12 hours. Thereafter, a precipitated solid was filtered off, washed with ethyl acetate, and thereafter, the filtrate was concentrated by evaporation, thereby obtaining 81 g of N-tertiary-butyl-cyanopropylamine as a crude product.

Next, to a 1000 mL three-necked flask, were introduce 43 g of acryloyl chloride (commercial product; manufactured by Tokyo Chemical Industry Co., Ltd.) and 200 g of ethyl acetate, and the mixture was cooled to 5° C. To this, was added dropwise 200 g of an ethyl acetate solution of 80 g of N-tertiary-butyl-cyanopropylamine and 58 g of triethyl amine (commercial product; manufactured by Tokyo Chemical Industry Co., Ltd.). After completion of the dropwise addition, the temperature of the reaction liquid was returned to room temperature and the reaction was performed for three hours. Thereafter, the reaction product was extracted with ethyl acetate, and washed with aqueous sodium hydrogencarbonate solution and salted water, and subsequently, after the extract was dried with magnesium sulfate and was filtered, the filtrate was concentrated by using an evaporator. The concentrated filtrate was purified by using a silica gel column (development solution; hexane/ethyl acetate=3/1), thereby obtaining 70 g of N-tertiary-butyl-cyanopropyl acrylamide.

Next, 15.4 g of dimethyl carbonate was introduced into a 300 ml three-necked flask, and was heated to 65° C. in a stream of nitrogen. To this, 4.18 g of 2-hydroxyethyl acrylate (commercial product; manufactured by Tokyo Chemical Industry Co., Ltd.), 16.32 g of N-tertiary-butyl-cyanopropyl acrylamide, and 15.4 g of dimethyl carbonate solution containing 0.238 g of V-65 (trade name; manufactured by Wako Pure Chemical Industries, Ltd.) were added dropwise over 4 hours. After completion of the dropwise addition, the mixture was stirred for 3 hours. Thereafter, 7 g of dimethyl carbonate was added to the mixture, and the reaction solution was cooled to room temperature.

To this reaction solution, were added 0.097 g of TEMPO (trade name; manufactured by Tokyo Chemical Industry Co., Ltd.), 0.289 g of U-600 (trade name; manufactured by Nitto Kasei Kogyo K. K.), 8.8 g of KARENZ AOI (trade name; manufactured by Showa Denko K.K.), and 8.8 g of acetonitrile, and the reaction solution was reacted at 45° C. for 6 hours. Thereafter, 1.1 g of water was added to the reaction solution, and the mixture was further reacted for 1.5 hours. After the completion of the reaction, reprecipitation was conducted with a mixed solution of ethyl acetate and hexane (1/2), and a solid product was collected, thereby obtaining 15 g of cyano group-containing polymerizable polymer D of the invention.

The structure of the cyano group-containing polymerizable polymer D in a state where the polymer was dissolved in d-DMSO and the solution was heated at 50° C. was identified by ¹H-NMR by using an NMR (manufactured by Bruker Corporation (400 MHz)). The polymer was dissolved in NMP, and the molecular weight of the polymer was measured by using a high performance GPC (trade name: HLC-8220GPC; manufactured by Tosoh Corporation). In addition, the molecular weight was calculated by polystyrene conversion. The weight average molecular weight of the cyano group-containing polymerizable polymer D was 51,000. Cyano group-containing polymerizable polymer D has the following units.

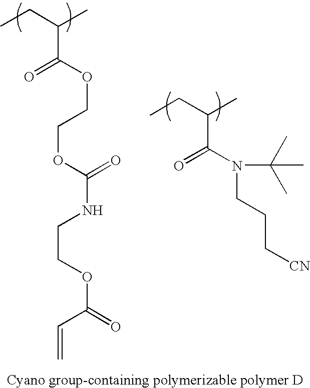

### Example 5

### Synthetic Example: Synthesis of Cyano Group-Containing Polymerizable Polymer E

In a 300 ml three-necked flask, was introduced 15.4 g of dimethyl carbonate, and was heated to 65° C. in a stream of nitrogen. To this, 2.79 g of 2-hydroxyethyl acrylate (commercial product; manufactured by Tokyo Chemical Industry Co., Ltd.), 16.09 g of N-tertiary-butyl-cyanopropyl acrylamide, 1.65 g of cyanoethyl acrylate, and 15.4 g of dimethyl carbonate solution containing 0.357 g of V-65 (trade name; manufactured by Wako Pure Chemical Industries, Ltd.) were added dropwise over 4 hours. After the completion of the dropwise addition, the mixture was further stirred for 3 hours. Thereafter, the reaction solution was cooled to room temperature.

To this reaction solution, were added 0.075 g of TEMPO (trade name; manufactured by Tokyo Chemical Industry Co., Ltd.), 0.223 g of U-600 (trade name; manufactured by Nitto Kasei Kogyo K. K.), 6.8 g of KARENZ AOI (trade name; manufactured by Showa Denko K.K.), and 6.8 g of acetonitrile, and the reaction solution was further reacted at 45° C. for 6 hours. Thereafter, 0.9 g of water was added to the reaction solution, and the mixture was further reacted for 1.5 hours. After the completion of the reaction, reprecipitation was conducted with a mixed solution of ethyl acetate and hexane (1/2), and a solid product was collected, thereby obtaining 14 g of the cyano group-containing polymerizable polymer E of the invention.

The structure of the cyano group-containing polymerizable polymer E, in a state where the polymer was dissolved in d-DMSO and the solution was heated at 50° C., was identified by ¹H-NMR by using an NMR (manufactured by Bruker Corporation (400 MHz)). The polymer was dissolved in NMP, and the molecular weight of the polymer was measured by using a high performance GPC (trade name: HLC-8220GPC; manufactured by Tosoh Corporation). In addition, the molecular weight was calculated by polystyrene conversion. The weight average molecular weight of the cyano group-containing polymerizable polymer E was 72,000. Cyano group-containing polymerizable polymer E has the following units.

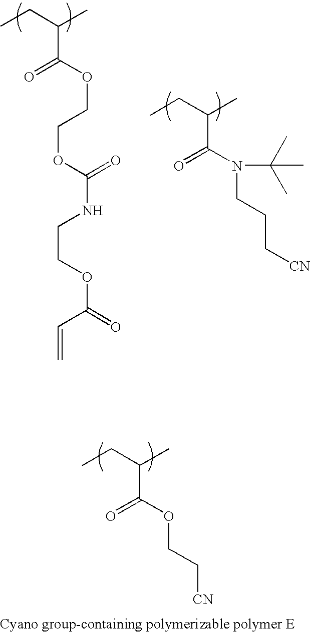

### Example 6

### Synthetic Example: Synthesis of Cyano Group-Containing Polymerizable Polymer F

In a 300 ml three-necked flask, was introduced 14.1 g of dimethyl carbonate, and was heated to 65° C. in a stream of nitrogen. To this, 2.79 g of 2-hydroxyethyl acrylate (commercial product; manufactured by Tokyo Chemical Industry Co., Ltd.), 15.39 g of N-tertiary-butyl-cyanopropyl acrylamide, 0.60 g of cyanoethyl acrylate, and 14.1 g of dimethyl carbonate solution containing 0.357 g of V-65 (trade name; manufactured by Wako Pure Chemical Industries, Ltd.) were added dropwise over 4 hours. After the completion of the dropwise addition, the mixture was further stirred for 3 hours. Thereafter, the reaction solution was cooled to room temperature.

To this reaction solution, were added 0.075 g of TEMPO (trade name; manufactured by Tokyo Chemical Industry Co., Ltd.), 0.223 g of U-600 (trade name; manufactured by Nitto Kasei Kogyo K. K.), 6.8 g of KARENZ AOI (trade name; manufactured by Showa Denko K.K.), and 6.8 g of acetonitrile, and the reaction solution was reacted at 45° C. for 6 hours. Thereafter, 0.9 g of water was added to the reaction solution, and the mixture was further reacted for 1.5 hours. After the completion of the reaction, reprecipitation was conducted with a mixed solution of ethyl acetate and hexane (1/2), and a solid product was collected, thereby obtaining 13 g of the cyano group-containing polymerizable polymer F of the invention.

The structure of the cyano group-containing polymerizable polymer F, in a state where the polymer was dissolved in d-DMSO and the solution was heated at 50° C., was identified by ¹H-NMR by using an NMR (manufactured by Bruker Corporation (400 MHz)). The polymer was dissolved in NMP, and the molecular weight of the polymer was measured by using a high performance GPC (trade name: HLC-8220GPC; manufactured by Tosoh Corporation). In addition, the molecular weight was calculated by polystyrene conversion. The weight average molecular weight of the cyano group-containing polymerizable polymer F was 55,000. Cyano group-containing polymerizable polymer F has the following units.

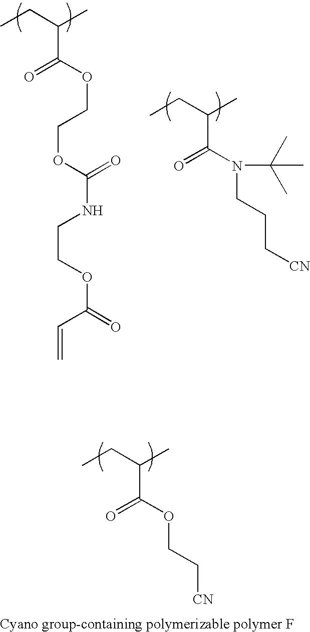

### Example 7

### Synthetic Example: Synthesis of Cyano Group-Containing Polymerizable Polymer G

In a 300 ml three-necked flask, was placed 14.7 g of dimethyl carbonate, and was heated to 65° C. in a stream of nitrogen. To this, 5.57 g of 2-hydroxyethyl acrylate (commercial product; manufactured by Tokyo Chemical Industry Co., Ltd.), 13.99 g of N-tertiary-butyl-cyanopropyl acrylamide, 1.65 g of cyanoethyl acrylate, and 14.7 g of dimethyl carbonate solution containing 0.357 g of V-65 (trade name; manufactured by Wako Pure Chemical Industries, Ltd.) were added dropwise over 4 hours. After the completion of the dropwise addition, the mixture was stirred for 3 hours. Thereafter, the reaction solution was cooled to room temperature.

To this reaction solution, were added 0.070 g of TEMPO (trade name; manufactured by Tokyo Chemical Industry Co., Ltd.), 0.208 g of U-600 (trade name; manufactured by Nitto Kasei Kogyo K.K.), 6.3 g of KARENZ AOI (trade name; manufactured by Showa Denko K.K.), and 6.3 g of acetonitrile, and the reaction solution was reacted at 45° C. for 6 hours. Thereafter, 0.9 g of water was added to the reaction solution, and the mixture was further reacted for 1.5 hours. After the completion of the reaction, reprecipitation was conducted with a mixed solution of ethyl acetate and hexane (1/4), and a solid product was collected, thereby obtaining 14 g of the cyano group-containing polymerizable polymer G of the invention.

The structure of the cyano group-containing polymerizable polymer G, in a state where the polymer was dissolved in d-DMSO and the solution was heated at 50° C., was identified by ¹H-NMR by using an NMR (manufactured by Bruker Corporation (400 MHz)). The polymer was dissolved in NMP, and the molecular weight of the polymer was measured by using a high performance GPC (trade name: HLC-8220GPC; manufactured by Tosoh Corporation). In addition, the molecular weight was calculated by polystyrene conversion. The weight average molecular weight of the cyano group-containing polymerizable polymer G was 45,000. Cyano group-containing polymerizable polymer G has the following units.

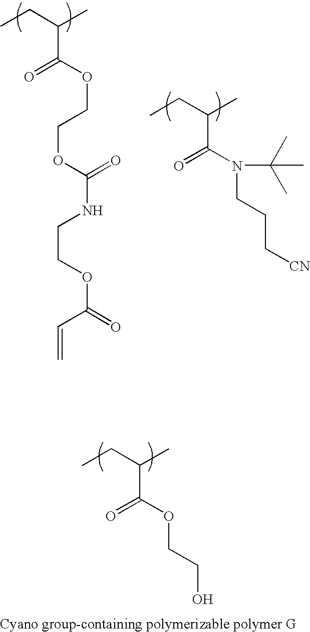

### Comparative Example 1

### Synthesis of Comparative Polymer A

In a 300 ml three-necked flask, was placed 24 g of N,N-dimethylacetamide and was heated to 65° C. in a stream of nitrogen. To this, 6.1 g of 2-hydroxyethyl acrylate (commercial product; manufactured by Tokyo Chemical Industry Co., Ltd.), 26 g of 2-cyanoethyl acrylamide, and 22 g of a dimethylacetamide solution containing 0.517 g of V-65 (trade name; manufactured by Wako Pure Chemical Industries, Ltd.) were added dropwise over 4 hours. After completion of the dropwise addition, the mixture was stirred for 3 hours. Thereafter, the reaction solution was cooled to room temperature.

To this reaction solution, were added 0.144 g of TEMPO (trade name; manufactured by Tokyo Chemical Industry Co., Ltd.), 0.43 g of U-600 (trade name; manufactured by Nitto Kasei Kogyo K. K.), 12.9 g of KARENZ AOI (trade name; manufactured by Showa Denko K.K.), and 12.9 g of N,N-dimethylacetamide, and the reaction solution was reacted at 45° C. for 6 hours. Thereafter, 1.7 g of water was added to the reaction solution, and the mixture was further reacted for 1.5 hours. After completion of the reaction, reprecipitation was conducted with a mixed solution of ethyl acetate and hexane (1/1), and a solid product was collected to obtain 15 g of Comparative Polymer A.

The structure of Comparative polymer A in a state where the polymer was dissolved in d-DMSO and the solution was heated at 50° C. was identified by ¹H-NMR by using an NMR (manufactured by Bruker Corporation (400 MHz)). The polymer was dissolved in NMP, and the molecular weight of the polymer was measured by using a high performance GPC (trade name: HLC-8220GPC; manufactured by Tosoh Corporation). In addition, the molecular weight was calculated by polystyrene conversion. The weight average molecular weight of Comparative polymer A was 28,000. Comparative polymer A has the following units.

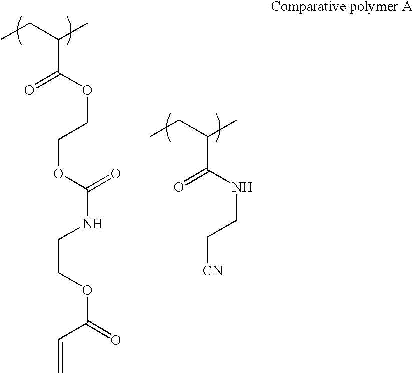

<Evaluation of Water Absorptivity>

Using the cyano group-containing polymerizable polymers A to G synthesized in Examples 1 to 7, and comparative polymer A synthesized in Comparative Example 1, evaluation of water absorptivity was performed.

Sample films of eight kinds of the polymers prepared in the following manner were allowed to stand under the conditions of 85° C. and 85% RH for three days, and the water absorptivity (%) of the sample films was evaluated.

Each sample film to be measured was prepared in such a manner that a solution prepared by dissolving 0.78 g of each polymer in a solvent (9 g of acetone) was casted on a Petri dish made by TEFLON (registered trademark) having a diameter of 10 cm, and the resultant film was allowed stand for one week at room temperature, followed by drying the film under reduced pressure. The thickness of each sample film was about 100 μm

The water absorptivity (%) was calculated based on the change in weight of the sample film measured by using a precision balance.

The result of evaluation of water absorptivity is as follows:

| <Kind of Polymer> | <Water Absorption> |
|---|---|
| Cyano group-containing polymerizable polymer A | 0.1% by mass or less |
| Cyano group-containing polymerizable polymer B | 1.4% by mass |
| Cyano group-containing polymerizable polymer C | 5.2% by mass |
| Cyano group-containing polymerizable polymer D | 0.1% by mass or less |
| Cyano group-containing polymerizable polymer E | 1.0% by mass |
| Cyano group-containing polymerizable polymer F | 0.1% by mass or less |
| Cyano group-containing polymerizable polymer G | 4.5% by mass |
| Comparative Polymer A | 9.8% by mass |

As shown by the above results, it was confirmed that the cyano group-containing polymerizable polymers A to G of the invention have lower water absorptivity in comparison with that of the comparative polymer A.

### Example 8

### Production of Substrate

An epoxy-based insulating film (trade name: GX-13, manufactured by Ajinomoto Fine-Techno Co., Inc., film thickness: 45 μm) as an electrical insulation layer was heated and pressurized on a glass epoxy substrate, and adhered to the substrate by using a vacuum laminator at a pressure of 0.2 MPa under the conditions of 100° C. to 110° C., and thus a base material A was obtained.

Subsequently, an insulative composition containing a polymerization initiator having the following composition, was applied onto the base material A by a spin coating method to a thickness of 3 μm, was allowed to stand for 1 hour at 30° C. to remove the solvent, and dried at 140° C. for 30 minutes, to form a polymerization initiation layer (insulative polymerization initiation layer).

(Insulative Composition Containing Polymerization Initiator)

A liquid bisphenol A type epoxy resin (trade name: EPIKOTE 825, manufactured by Japan Epoxy Resin Co., Ltd., epoxy equivalent: 176) (5 g), 2 g of an MEK varnish of a triazine structure-containing phenol novolac resin (trade name: PHENOLITE LA-7052, manufactured by Dainippon Ink & Chemicals, Inc., non-volatile component: 62%, phenolic hydroxyl group equivalent of non-volatile component: 120), 10.7 g of an MEK varnish of a phenoxy resin (trade name: YP-50EK35, manufactured by Toto Chemical Corp., non-volatile component: 35%), 2.3 g of 2-hydroxy-4′-(2-hydroxyethoxy)-2-methylpropiophenone as a polymerization initiator, 5.3 g of MEK, and 0.053 g of 2-ethyl-4-methylimidazole were mixed and were completely dissolved with stirring, and thus an insulative composition containing a polymerization initiator was obtained.

After the polymerization initiation layer as described above was formed, and was subjected to a curing treatment at 180° C. for 30 minutes, thereby obtaining a substrate A1. The surface roughness (Rz) of this substrate A1 was 0.2 μm.

<Formation of Polymer Layer>

(Preparation of Coating Solution)

The cyano group-containing polymerizable polymer A (10.5 parts by mass) of the invention obtained in Synthetic Example above, 73.3 parts by mass of acetone, 33.9 parts by mass of methanol, and 4.8 parts by mass of N,N-dimethylacetamide were mixed and stirred, to prepare a coating solution.

(Exposure)

The prepared coating solution was applied onto the polymerization initiation layer of Substrate A1, by a spin coating method to a thickness of 1 μm. This film was dried at 80° C. for 30 minutes, and then was irradiated for 660 seconds by using a UV exposure unit (trade name: UVF-502S, manufactured by San-Ei Electric Co., Ltd., lamp: UXM-501MD) at an irradiation power of 1.5 mW/cm² (measured by an accumulated UV meter (trade name: UIT150 with a photoreceptive sensor (trade name: UVD-S254 manufactured by Ushio Inc.), to react cyano group-containing polymerizable polymer A with the entire surface of the polymerization initiation layer of the substrate A1.

Subsequently, the substrate having a polymer layer formed thereon was immersed for 5 minutes in acetone with stirring, followed by washing the substrate with distilled water.

In this way, a substrate A2 having a polymer layer was obtained.

<Application of Plating Catalyst>

The substrate A2 having a polymer layer was immersed in a 1% acetone solution of palladium for 30 minutes, followed by immersing and washing the substrate in acetone.

Subsequently, a mixed solution of 1% dimethylborane-water/methanol (water/methanol=1/3) was used as a catalyst activating liquid (reducing liquid), and the substrate A2 having a polymer layer was immersed in this solution for 15 minutes, followed by immersing and washing the substrate in acetone.

<Electroless Plating>

The substrate A2 having a polymer layer, to which a plating catalyst was applied, was subjected to electroless plating by using an electroless plating bath having the following composition, at 60° C. for 5 minutes. The obtained electroless copper plating film had a thickness of 0.3 μm.

Composition of Electroless Plating Bath

| | | |
|---|---|---|
| Distilled water | 859 | g |
| Methanol | 850 | g |
| Copper sulfate | 18.1 | g |
| Ethylenediaminetetraacetic acid•disodium salt | 54.0 | g |
| Polyoxyethylene glycol (molecular weight: 1,000) | 0.18 | g |
| 2,2′-Bipyridyl | 1.8 | mg |
| 10% Aqueous solution of ethylenediamine | 7.1 | g |
| 37% Aqueous solution of formaldehyde | 9.8 | g |

The pH value of the plating bath having the above composition was adjusted to 12.5 (60° C.) with sodium hydroxide and sulfuric acid.

<Electroplating>

Subsequently, electroplating was performed for 20 minutes by using the electroless copper plating film as a power supply layer, and using a copper electroplating bath having the following composition, under the condition of 3 A/dm². The obtained copper electroplating film had a thickness of 18 μm.

(Composition of Electroplating Bath)

| | | |
|---|---|---|
| Copper sulfate | 38 | g |
| Sulfuric acid | 95 | g |
| Hydrochloric acid | 1 | mL |
| Copper Gleam PCM (trade name, manufactured by Meltex, | 3 | mL |
| Inc.) | | |
| Water | 500 | g |

<Evaluation of Adhesiveness of Metal Film>

For the obtained plating film, the 90° peel strength was measured for a width of 5 mm, using a tensile tester (Autograph; manufactured by Shimadzu Corp.) at a tensile strength of 10 mm/min, and the strength was 0.5 kN/mm.

<Formation of Metallic Pattern and Insulation Reliability Test>

On the surface of the obtained plating film, was formed an etching resist on the areas to be remained as a metallic pattern (wiring pattern), and the plating film in the areas where the resist was not formed, was removed with an etching solution containing FeCl₃/HCl. Subsequently, the etching resist was removed with an alkali stripping liquid formed from a 3% NaOH solution, and comb-shaped wiring (metallic pattern-bearing material) with line-and-space=100 μm/90 μm, for measuring the inter-wiring insulation reliability, was formed.

This comb-shaped wiring was allowed to stand for 200 hours in a HAST tester (trade name: AMI-150S-259; manufactured by ESPEC Corp.), at a temperature of 125° C. and a relative humidity of 85% (unsaturated) and at an applied voltage of 10 V under a pressure of 2 atmospheres, but no defects in the inter-wiring insulation were observed.

### Example 9

### Formation of Polymer Layer

### (Preparation of Coating Solution)

The cyano group-containing polymerizable polymer E (10.5 parts by mass) of the invention obtained in Synthetic Example above, 73.3 parts by mass of acetone, 33.9 parts by mass of methanol, and 4.8 parts by mass of N,N-dimethylacetamide were mixed and stirred, to prepare a coating solution.

(Exposure)

The prepared coating solution was applied onto the polymerization initiation layer of Substrate A1, by a spin coating method to a thickness of 1 μm. This film was dried at 80° C. for 30 minutes, and then was irradiated for 660 seconds by using a UV exposure unit (Model No. UVF-502S; manufactured by San-Ei Electric Co., Ltd., lamp: UXM-501MD) at an irradiation power of 1.5 mW/cm² (the irradiation power was measured by an accumulated UV meter (trade name: UIT150 with a photoreceptive sensor (trade name: UVD-S254 manufactured by Ushio Inc.), thereby reacting the cyano group-containing polymerizable polymer with the entire surface of the polymerization initiation layer of the substrate A1.

Subsequently, the substrate having the polymer layer formed thereon was immersed for 5 minutes in acetone with stirring, followed by washing the substrate with distilled water.

In this way, a substrate A3 having a polymer layer was obtained.

<Application of Plating Catalyst>

The substrate A3 having the polymer layer was immersed in a 1% acetone solution of palladium for 30 minutes, followed by immersing and washing the substrate in acetone.

Subsequently, a mixed solution of 1% dimethyl aminoborane-water/methanol (water/methanol=1/3) was used as a catalyst activating liquid (reducing liquid), and the substrate A3 having the polymer layer was immersed in this solution for 15 minutes, followed by immersing and washing the substrate in acetone.

<Electroless Plating>

The substrate A3 having the polymer layer, to which a plating catalyst was applied, was subjected to electroless plating by using an electroless plating bath similar to that of Example 4 at 60° C. for 3 minutes. The obtained electroless copper plating film had a thickness of 0.4 μm.

<Electroplating>

Subsequently, electroplating was performed for 20 minutes by using the electroless copper plating film as a power supply layer, and using a copper electroplating bath similar to Example 4 under the condition of 3 A/dm². Thereafter, baking treatment was performed at 120° C. for one hour. The obtained copper electroplating film had a thickness of 19 μm.

<Evaluation of Adhesiveness of Metal Film>

For the obtained plating film, the 90° peel strength was measured for a width of 5 mm, using a tensile tester (Autograph; manufactured by Shimadzu Corp.) at a tensile strength of 10 mm/min, and the strength was 0.7 kN/mm. It turns out that the film becomes more flexible, and the adhesiveness is enhanced as compared with those of Example 8

<Formation of Metallic Pattern and Insulation Reliability Test>

On the surface of the obtained plating film, was formed an etching resist on the areas to be remained as a metallic pattern (wiring pattern), and the plating film in the areas where the resist was not formed, was removed with an etching solution containing FeCl₃/HCl. Subsequently, the etching resist was removed with an alkali stripping liquid formed from a 3% NaOH solution, and a comb-shaped wiring (metallic pattern-bearing material) with line-and-space=110 μm/90 μm, for measuring the inter-wiring insulation reliability, was formed.

This comb-shaped wiring was allowed to stand for 200 hours in a HAST tester (trade name: AMI-150S-25; manufactured by ESPEC Corp.), at a temperature of 125° C. and a relative humidity of 85% (unsaturated) and at an applied voltage of 10 V under a pressure of 2 atmospheres, but no defects in the inter-wiring insulation were observed.

### Example 10

### Formation of Polymer Layer

### (Preparation of Coating Solution)

The cyano group-containing polymerizable polymer F (10.5 parts by mass) of the invention obtained in Synthetic Example above, 73.3 parts by mass of acetone, 33.9 parts by mass of methanol, and 4.8 parts by mass of N,N-dimethylacetamide were mixed and stirred, to prepare a coating solution.

(Exposure)

The prepared coating solution was applied onto the polymerization initiation layer of Substrate A1, by a spin coating method to a thickness of 1 μm. This film was dried at 80° C. for 30 minutes, and then was irradiated for 660 seconds by using a UV exposure unit (Model No. UVF-502S; manufactured by San-Ei Electric Co., Ltd., lamp: UXM-501MD) at an irradiation power of 1.5 mW/cm² (the irradiation power was measured by an accumulated UV meter (trade name: UIT150 with a photoreceptive sensor (trade name: UVD-S254 manufactured by Ushio Inc.), thereby reacting the cyano group-containing polymerizable polymer with the entire surface of the polymerization initiation layer of the substrate A1.

Subsequently, the substrate having the polymer layer formed thereon was immersed for 5 minutes in acetone with stirring, followed by washing the substrate with distilled water.

In this way, a substrate A4 having a polymer layer was obtained.

<Application of Plating Catalyst>

The substrate A4 having the polymer layer was immersed in a 1% acetone solution of palladium for 30 minutes, followed by immersing and washing the substrate in acetone.

Subsequently, a mixed solution of 1% dimethyl aminoborane-water/methanol (water/methanol=1/3) was used as a catalyst activating liquid (reducing liquid), and the substrate A4 having the polymer layer was immersed in this solution for 15 minutes, followed by immersing and washing the substrate in acetone.

<[Electroless Plating>

The substrate A4 having the polymer layer, to which a plating catalyst was applied, was subjected to electroless plating by using an electroless plating bath similar to that of Example 4 at 60° C. for 5 minutes. The obtained electroless copper plating film had a thickness of 0.3 μm.

<Electroplating>

Subsequently, electroplating was performed for 20 minutes by using the electroless copper plating film as a power supply layer, and using a copper electroplating bath similar to Example 4 under the condition of 3 A/dm². Thereafter, a baking treatment was performed at 120° C. for one hour. The obtained copper electroplating film had a thickness of 18 μm.

<Evaluation of Adhesiveness of Metal Film>

For the obtained plating film, the 90° peel strength was measured for a width of 5 mm, using a tensile tester (Autograph; manufactured by Shimadzu Corp.) at a tensile strength of 10 mm/min, and the strength was 0.5 kN/mm.

<Formation of Metallic Pattern and Insulation Reliability Test>

On the surface of the obtained plating film, was formed an etching resist on the areas to be remained as a metallic pattern (wiring pattern), and the plating film in the areas where the resist was not formed, was removed with an etching solution containing FeCl₃/HCl. Subsequently, the etching resist was removed with an alkali stripping liquid formed from a 3% NaOH solution, and a comb-shaped wiring (metallic pattern-bearing material) with line-and-space=110 μm/90 μm, for measuring the inter-wiring insulation reliability, was formed.

This comb-shaped wiring was allowed to stand for 200 hours in a HAST tester (trade name: AMI-150S-25; manufactured by ESPEC Corp.), at a temperature of 125° C. and a relative humidity of 85% (unsaturated) and at an applied voltage of 10 V under a pressure of 2 atmospheres, but no defects in the inter-wiring insulation were observed.

All publications, patent applications, and technical standards mentioned in this specification are herein incorporated by reference to the same extent as if each individual publication, patent applications, or technical standards was specifically and individually indicated to be incorporated by reference.

What is claimed is:

1. A polymer containing a unit represented by the following Formula (1) and a unit represented by the following Formula (2): 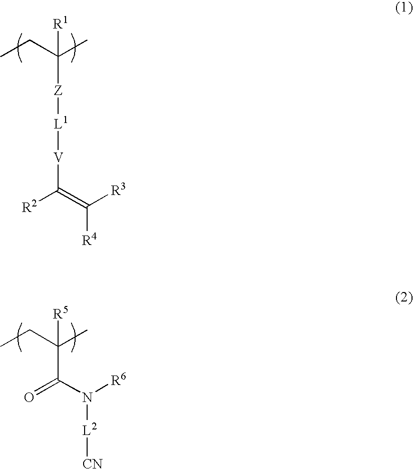
wherein R¹ to R⁵ each independently represents a hydrogen atom or a substituted or unsubstituted alkyl group; R⁶ represents an unsubstituted alkyl group, an alkenyl group, an alkynyl group or an aryl group; V and Z each independently represents a single bond, a substituted or unsubstituted divalent organic group, an ester group, an amide group or an ether group; and L¹ and L² each independently represent a substituted or unsubstituted divalent organic group.

2. The polymer according to claim 1, wherein R⁶ in Formula (2) is a substituent having a branched chain structure.

3. The polymer according to claim 1, wherein R⁶ in Formula (2) is an alkyl group having a branched structure having a total number of carbon atoms of 3 to 6, or an aryl group having a total number of carbon atoms of 6 to 8.

4. The polymer according to claim 1, wherein R⁶ in Formula (2) is a methyl group, an ethyl group, a propyl group, an isopropyl group, a butyl group, an isobutyl group, a t-butyl group, a pentyl group, an s-pentyl group, an isopentyl group, a cyclopentyl group, a hexyl group, a cyclohexyl group, a heptyl group, a cycloheptyl group, an octyl group, a nonyl group, a decanyl group, an ethylene group, an allyl group, an acetylene group or a phenyl group.

5. The polymer according to claim 1, wherein R⁶ in Formula (2) is a t-butyl group, a cyclohexyl group or a phenyl group.

6. A composition comprising the polymer according to claim 1 and a solvent in which the polymer is soluble.

7. The composition according to claim 6, wherein the concentration of the polymer is from 2% by mass to 50% by mass.

8. A laminate body formed by applying the composition according to claim 7 onto a resin base material.

9. A method of producing a metal film-coated material comprising:
forming a polymer layer using a composition containing the polymer according to claim 1;
applying a plating catalyst or a precursor of the catalyst to the polymer layer; and
performing plating on the plating catalyst or a precursor of the catalyst.

10. The method of producing a metal film-coated material according to claim 9, wherein the polymer in the polymer layer is directly chemically bonded to a substrate.

11. A metal film-coated material obtained by the method of producing a metal film-coated material according to claim 9.

12. A method of producing a metallic pattern-bearing material comprising:
pattern-wise etching the metal film-coated material obtained by the method of producing a metal film-coated material according to claim 9.

13. A metallic pattern-bearing material obtained by the method of producing a metallic pattern-bearing material according to claim 12.
